(19) United States
(12) Patent Application Publication
(10) Pub. No.: US 2025/0095283 A1
(43) Pub. Date: Mar. 20, 2025

(54) IMAGE BACKGROUND EFFECTS

(71) Applicant: QUALCOMM Incorporated, San Diego, CA (US)

(72) Inventors: Eran PINHASOV, Zichron Yaakov (IL); Eran SCHARAM, Misgav (IL)

(21) Appl. No.: 18/468,622

(22) Filed: Sep. 15, 2023

(51) Int. Cl. G06T 15/50; G06T 7/194; G06T 7/70; H04N 5/272; H04N 5/74; H04N 23/68

(52) U.S. Cl. CPC G06T 15/506; G06T 7/194; G06T 7/70; H04N 5/272; H04N 5/74; H04N 23/683

(57) ABSTRACT

Systems and techniques are provided for processing image data. A process can include determining an estimated camera pose corresponding to image data and generating a background replacement view of a configured three-dimensional (3D) content. The background replacement view can be associated with an angle-of-view (AOV) based on the estimated camera pose. A segmentation mask can be determined for the image data, indicative of a foreground portion of the image data and a background portion of the image data. A relighting image can be generated corresponding to at least a portion of the image data, wherein the relighting image is based on the segmentation mask and lighting information of the configured 3D content. An output image can be generated based on the relighting image and the background replacement view of the configured 3D content.

### FIELD

The present disclosure generally relates to image processing. For example, aspects of the present disclosure are related to systems and techniques for performing video background replacement.

### BACKGROUND

Many devices and systems allow a scene to be captured by generating images (or frames) and/or video data (including multiple frames) of the scene. For example, a camera or a device including a camera can capture one or more images of a scene (e.g., a still image of the scene, one or more frames of a video of the scene, etc.). In some cases, the one or more images can be processed for performing one or more functions, can be output for display, can be output for processing and/or consumption by other devices, among other uses.

A common type of processing performed on images is image segmentation, which involves segmenting image and video frames into multiple portions. For example, image and video frames can be segmented into foreground and background portions. In some examples, semantic segmentation can segment image and video frames into one or more segmentation masks based on object classifications. For example, one or more pixels of the image and/or video frames can be segmented into classifications such as human, hair, skin, clothes, house, bicycle, bird, background, etc. The segmented image and video frames can then be used for various applications. Applications that use image segmentation are numerous, including, for example, computer vision systems, image augmentation and/or enhancement, image background replacement, extended reality (XR) systems, augmented reality (AR) systems, image segmentation, autonomous vehicle operation, among other applications.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for image processing. According to at least one illustrative example, a method of processing image data is provided. The method includes: determining an estimated camera pose corresponding to image data; generating a background replacement view of a configured three-dimensional (3D) content, wherein the background replacement view is associated with an angle-of-view (AOV) based on the estimated camera pose; determining a segmentation mask for the image data, the segmentation mask indicative of a foreground portion of the image data and a background portion of the image data; generating a relighting image corresponding to at least a portion of the image data, wherein the relighting image is based on the segmentation mask and lighting information of the configured 3D content; and generating an output image based on the relighting image and the background replacement view of the configured 3D content.

In another illustrative example, an apparatus for processing image data is provided. The apparatus includes at least one memory and at least one processor coupled to the at least one memory and configured to: determine an estimated camera pose corresponding to image data; generate a background replacement view of a configured three-dimensional (3D) content, wherein the background replacement view is associated with an angle-of-view (AOV) based on the estimated camera pose; determine a segmentation mask for the image data, the segmentation mask indicative of a foreground portion of the image data and a background portion of the image data; generate a relighting image corresponding to at least a portion of the image data, wherein the relighting image is based on the segmentation mask and lighting information of the configured 3D content; and generate an output image based on the relighting image and the background replacement view of the configured 3D content.

In another illustrative example, a non-transitory computer-readable storage medium comprising instructions stored thereon which, when executed by at least one processor, causes the at least one processor to: determine an estimated camera pose corresponding to image data; generate a background replacement view of a configured three-dimensional (3D) content, wherein the background replacement view is associated with an angle-of-view (AOV) based on the estimated camera pose; determine a segmentation mask for the image data, the segmentation mask indicative of a foreground portion of the image data and a background portion of the image data; generate a relighting image corresponding to at least a portion of the image data, wherein the relighting image is based on the segmentation mask and lighting information of the configured 3D content; and generate an output image based on the relighting image and the background replacement view of the configured 3D content.

In another illustrative example, an apparatus is provided for processing image data. The apparatus includes: means for determining an estimated camera pose corresponding to image data; means for generating a background replacement view of a configured three-dimensional (3D) content, wherein the background replacement view is associated with an angle-of-view (AOV) based on the estimated camera pose; means for determining a segmentation mask for the image data, the segmentation mask indicative of a foreground portion of the image data and a background portion of the image data; means for generating a relighting image corresponding to at least a portion of the image data, wherein the relighting image is based on the segmentation mask and lighting information of the configured 3D content; and means for generating an output image based on the relighting image and the background replacement view of the configured 3D content.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 illustrates an example architecture of a system for background replacement video generation based on a three-dimensional (3D) scene, in accordance with some examples;

FIG. 4 illustrates an example architecture of a system for background replacement video generation based on a 360-degree image, in accordance with some examples;

FIG. 5 illustrates an example of a camera position estimation engine that can be used with the background replacement video generation systems of FIG. 3 and/or FIG. 4, in accordance with some examples;

FIG. 6 illustrates an example of a camera motion stabilization engine that can be used with the background replacement video generation system of FIG. 3, in accordance with some examples;

FIG. 7 illustrates an example of a camera motion stabilization engine that can be used with the background replacement video generation system of FIG. 4, in accordance with some examples;

FIG. 8 illustrates an example of a background generation engine that can be used with the background replacement video generation system of FIG. 3, in accordance with some examples;

FIG. 9 illustrates an example of a viewport and high dynamic range image (HDRI) image generation engine that can be used with the background replacement video generation system of FIG. 4, in accordance with some examples;

FIG. 10A illustrates an example of a relighting engine that can be used with the background replacement video generation systems of FIG. 3 and/or FIG. 4, in accordance with some examples;

FIG. 10B illustrates an example of a background replacement engine that can be used with the background replacement video generation systems of FIG. 3 and/or FIG. 4, in accordance with some examples;

FIG. 11 is a flow diagram illustrating an example of a process for processing image and/or video data, in accordance with some examples; and

FIG. 12 is a block diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects of the application. However, it will be apparent that various aspects and examples may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims

Image semantic segmentation is a task of generating segmentation results for a frame of image data, such as a still image or photograph. Video semantic segmentation is a type of image segmentation that includes a task of generating segmentation results for one or more frames of a video (e.g., segmentation results can be generated for all or a portion of the image frames of a video). Image semantic segmentation and video semantic segmentation can be collectively referred to as “image segmentation” or “image semantic segmentation.” Segmentation results can include one or more segmentation masks generated to indicate one or more locations, areas, and/or pixels within a frame of image data that belong to a given semantic segment (e.g., a particular object, class of objects, etc.). For example, as explained further below, each pixel of a segmentation mask can include a value indicating a particular semantic segment (e.g., a particular object, class of objects, etc.) to which each pixel belongs. Image segmentation can additionally be used to determine information such as a corresponding confidence for the respective pixels included in the input image data (e.g., a confidence value for each respective pixel of the segmentation mask). Segmentation results (e.g., segmentation masks) can additionally be indicative of instance information, which may be indicative of differentiation between different objects belonging to the same class (e.g., an image may include five people each identified as belonging to the same class, and associated with a respective instance ID to uniquely distinguish each of the five, etc.).

In some examples, features can be extracted from an image frame and used to generate one or more segmentation masks for the image frame based on the extracted features. In some cases, machine learning can be used to generate segmentation masks based on the extracted features. For example, a convolutional neural network (CNN) can be trained to perform semantic image segmentation by inputting into the CNN many training images and providing a known output (or label) for each training image. The known output for each training image can include a ground-truth segmentation mask corresponding to a given training image.

In some cases, image segmentation can be performed to segment image frames into segmentation masks based on an object classification scheme (e.g., the pixels of a given semantic segment all belong to the same classification or class). For example, one or more pixels of an image frame can be segmented into classifications such as human, hair, skin, clothes, house, bicycle, bird, background, etc. In some examples, a segmentation mask can include a first value for pixels that belong to a first classification, a second value for pixels that belong to a second classification, etc. A segmentation mask can also include one or more classifications for a given pixel. For example, a “human” classification can have sub-classifications such as ‘hair,’ ‘face,’ or ‘skin,’ such that a group of pixels can be included in a first semantic segment with a ‘face’ classification and can also be included in a second semantic segment with a ‘human’ classification.

Segmentation masks can be used to apply one or more processing operations to a frame of image data. For instance, a system may perform image augmentation and/or image enhancement for a frame of image data based on a semantic segmentation mask generated for the frame of image data. In one example, the system may process certain portions of a frame with a particular effect, but may not apply the effect to a portion of the frame corresponding to a particular class indicated by a segmentation mask for the frame. Image augmentation and enhancement processes can include, but are not limited to, personal beautification, such as skin smoothing or blemish removal; background replacement or blurring; providing an extended reality (XR) experience (e.g., a virtual reality (VR), augmented reality (AR), or mixed reality (MR) experience); etc. Semantic segmentation masks can also be used to manipulate certain objects or segments in a frame of image data, for example by using the semantic segmentation mask to identify the pixels in the image frame that are associated with the object or portions to be manipulated. In one example, background objects in a frame can be artificially blurred to visually separate them from an in-focus or foreground object of interest (e.g., a person's face) identified by a segmentation mask for the frame (e.g., an artificial bokeh effect can be generated and applied based on the segmentation mask), where the object of interest is not blurred. In some cases, visual effects can be added to a frame of image data using the segmentation information.

Segmentation masks can be applied to frames of video data to identify and/or remove a background portion or one or more background objects from each frame of video data. A replacement background can be combined with the segmented foreground portion of each frame of video data to obtain a background replacement video. At least some existing approaches are not able to generate realistic or convincing background replacement video using the segmentation technique described above. For example, the input video data (e.g., the video data for which a background replacement video is generated) may be captured using a smartphone or other handheld device. Motion in the input video data, or otherwise associated with the capture of the input video data, is not represented as corresponding motion of the artificial (e.g., replacement) background in the background replacement video. In some cases, the lighting can differ between the input video data and the artificial (e.g., replacement) background, which may result in an unrealistic or unconvincing background replacement video. The accuracy of the segmentation between foreground and background in the input video data can also degrade with increasing video frame rate (e.g., in examples where background replacement video processing is performed in approximately real-time), can degrade with increased motion or movement between consecutive frames of video data, and/or can degrade with the presence of fine details or textures in the frames of video data (e.g., such as around hair or fur, etc.).

In some examples, background replacement video may also be generated using studio production techniques, such as green-screening with reference marks for positioning the artificial background relative to the moving subject (e.g., foreground object(s)) of the input video data. In some cases, computational-based tracking techniques are used to animate the computer-generated (CG) content of the artificial background to correspond to movement of the camera. In green-screening and other studio production techniques, the lighting of the 3D CG scene that is used as the artificial (e.g., replacement) background is reproduced on the real lighting conditions of the green-screen scene captured in the input video data. Green-screening for background replacement in video data can be a complex, time-consuming, and expensive process to perform. Green-screening may also be associated with “green spill” over the subjects and reflective surfaces in the foreground of the input image data, reducing the perceived visual quality and realism of the output background replacement video.

In some examples, background replacement video may be generated using virtual production techniques. Virtual production techniques can be based on combining live-action shots with one or more simultaneous digital effects (e.g., compared to green-screening approaches, where live-action shots are composited with digital effects at a later time). For instance, virtual production (VP) techniques can combine techniques such as pre-visualization, motion capture, augmented-reality, and/or real-time rendering, etc. For instance, real-time rendering and motion capture may be used to render 3D environments and characters in real-time. High-resolution video walls or projection systems can be used to display the real-time rendered content as a backdrop on the live-action set. Movement information of a camera used to capture the live-action footage can be used to provide a dynamic view of the real-time rendered environment(s). For example, the real-time rendered content can be displayed with adaptation to camera movement, such that parallax and perspective shifts are accurately represented in the real-time rendered content that is displayed on the live-action set. The use of LED or other video walls can additionally be used to provide scene lighting or scene lighting effects, with the digital environment naturally illuminating actors, physical set pieces, etc. In some cases, dedicated motion capture systems and/or motion capture hardware units (e.g., optical, inertial, electromagnetic, etc.) can be used in virtual production to track the movements of actors, cameras, and/or other on-set elements, etc. The precise movement information obtained by the dedicated motion capture system(s) can be fed to the real-time rendering engine or real-time rendering pipeline to more accurately synchronize camera movements (and corresponding rendered output(s)) between the physical and virtual elements and/or environments associated with the virtual production. For instance, the motion capture information can be used to ensure that both the virtual camera and the real camera match their movements, focal lengths, orientations, etc.

There is a need for systems and techniques that can be used to perform background replacement for video data without using green-screening or other studio production techniques such as virtual production. There is a further need for systems and techniques that can be used to perform background replacement for video data with replacement background scene imagery that tracks corresponding to motion of the camera and that utilizes consistent lighting across the foreground objects (e.g., from the input video data) and the background objects (e.g., from the replacement background scene imagery).

Systems, apparatuses, processes (also referred to as methods), and computer-readable media (collectively referred to as “systems and techniques”) are described herein that can be used to perform background replacement for video data. As used herein, background replacement for video data can also be referred to as “video background replacement.” Video background replacement can be performed to generated background replaced video data corresponding to an input video data and a three-dimensional (3D) replacement background data. In some aspects, the systems and techniques can be implemented using a mobile computing device such as a smartphone, etc., and can generate background replaced video without the need for a dedicated studio or video capture stage. For instance, the systems and techniques can perform background replacement for video data based on camera position tracking information obtained during the capture of an input video data. In some aspects, the camera position tracking information can be inertial information obtained using an inertial measurement unit (IMU) or other inertial measurement sensor included in the video capture device (e.g., mobile computing device, smartphone, etc.).

The camera position tracking information can be used to determine an estimated camera position in space for one or more (or all) of the respective frames of video data included in a video (e.g., where a video comprises a plurality of frames of video data). In some aspects, the camera position tracking information can be camera pose information. For instance, a camera position tracking engine can determine an estimated camera pose that includes a camera position (e.g., location in three-dimensional space) and a camera orientation (e.g., angular information, information indicative of a direction of view or optical axis of the camera, etc.). In some cases, the estimated camera pose can be a 6-degrees-of-freedom (6DOF) pose information. For example, 6DOF pose information can include information corresponding to six different axes (e.g., degrees of freedom) of the camera in three-dimensional space. 6DOF pose information can be indicative of the camera position along an X, Y, and Z axis (e.g., used to locate the camera in the three-dimensional space) and can additionally be indicative of the camera angular orientation or rotation along pitch, yaw, and roll axes (e.g., used to determine a direction of view (DOV) and/or optical axis of the camera).

In some cases, the camera orientation information included in the 6DOF pose estimation (e.g., pitch, yaw, and roll orientation or rotation) can be indicative of the viewing direction of the camera, from the current position of the camera in 3D space. The combination of camera pose information and camera angle-of-view (AOV), also referred to as field-of-view (FOV), can be used to determine a portion of a scene represented in an image captured by the camera in the estimated 6DOF pose. For instance, the camera pose information and camera AOV (e.g., FOV) information can be used to determine a portion of a 360° sphere comprising the surrounding scene or environment of the camera that is represented in an image captured by the camera. For instance, in one illustrative example, the systems and techniques can use the 6DOF camera pose estimation to generate a corresponding view of (e.g., into or within) a virtual three-dimensional (3D) scene or environment, where the view in the virtual 3D scene or environment is generated using the same (or similar) direction of view and AOV (e.g., FOV) as in an image captured by the camera. Based on relative changes in the camera pose in space (e.g., changes over time, such as between frames of video data), the view of the virtual 3D environment can be updated to represent a same or similar relative change.

In some aspects, the 6DOF camera pose estimation may additionally be used to perform camera motion stabilization. The camera motion stabilization can generate a stabilized virtual position of the camera, which may be used to perform replacement background generation (e.g., CG or artificial background generation). The replacement background generation and/or video background replacement described herein may, in at least some examples, be performed without camera motion stabilization (e.g., the systems and techniques may be used to process stabilized video or image data, or may be used to process un-stabilized video or image data). In some examples, camera motion stabilization can be implemented based on generating and/or applying a warp grid corresponding to one or more motion stabilizations calculated based on camera motion or IMU data. In some aspects, camera motion stabilization can be implemented based on obtaining stabilized image or video data from a camera (e.g., a camera implementing in-body or on-sensor stabilization, a camera coupled to a gimbal or other external stabilization device, etc.) In some examples, the replacement background generation can be performed using a graphics processing unit (GPU), neural processing unit (NPU), etc., of the image capture device. The camera motion stabilization can also be used to generate a stabilization warp grid, which can be provided to an image processing engine. The image processing engine can be an image signal processor (ISP), etc.

The ISP can process the input frames of video data in combination with the corresponding stabilization warp grid generated for each respective input frame of video data. The ISP can generate a corresponding stabilized video data based on applying the corresponding stabilization warp grid to each respective input frame of video data. The ISP may also perform or apply one or more additional ISP operations included in a main ISP processing implemented by the image capture device.

The input frames of video data can be provided to the camera position (e.g., camera pose) estimation engine in parallel with a segmentation engine. The segmentation engine can be implemented as a machine learning network (e.g., neural network, etc.) trained to perform image segmentation. In some aspects, the segmentation engine can segment an input frame of video data into at least a foreground portion and a background portion.

The CG background generation engine can use the stabilized camera virtual position (e.g., generated using the camera motion stabilization engine) to generate a CG background at a corresponding location, angle, angle-of-view (AOV), and/or field-of-view (FOV) for the currently processed frame of video data. As used herein, the terms angle-of-view (AOV) and field-of-view (FOV) may be used interchangeably. In some aspects, the CG background generation engine can generate the CG background frame or data based on a configured three-dimensional (3D) scene selected for use as the replacement background in the background replaced video. In some aspects, the CG background generation engine can use a configured 3D scene that is selected based on a user input indicative of a selection from a plurality of 3D scenes. In some cases, the 3D scenes can be previously generated 3D scenes. In some examples, the 3D scenes can be generated using one or more generative artificial intelligence (AI) models.

In one illustrative example, the CG background generation engine can generate the replacement background image data corresponding to the currently processed frame of video data based on using the stabilized camera virtual position information to obtain a frame of the 3D background scene with a camera location, angle, AOV, and/or FOV that corresponds (e.g., matches) to that of the stabilized camera virtual position information calculated for the currently processed frame of video data. In some aspects, the CG background generation engine can additionally generate a high dynamic range image (HDRI) image data for relighting. In some examples, the HDRI image data can be an HDRI 360 image (e.g., a 360° image in HDRI format). In some examples, the HDRI image data is always an HDRI 360 image and may be used to perform relighting based on the HDRI 360 image including information indicative of the light direction of the entire 360° scene.

The HDRI 360 image and the CG-generated background replacement data from the CG background generation engine can be provided to a relighting and background replacement engine. The relighting and background replacement engine can additionally receive as input the segmentation map (e.g., generated by the segmentation engine or segmentation neural network) for the currently processed frame, and the input frame of video data (e.g., the currently processed frame). The background of the input frame of video data can be replaced with the CG-generated background replacement data based on the corresponding segmentation map generated for the current frame. The relighting and background replacement engine can perform relighting based on the HDRI 360 image, to obtain consistent virtual lighting across the foreground object(s) of the input frame of video data and the background object(s) of the CG-generated background replacement data. The relighting and background replacement engine can generate as output a background replaced video data comprising a plurality of background replaced frames of video data.

Various aspects of the present disclosure will be described with respect to the figures.

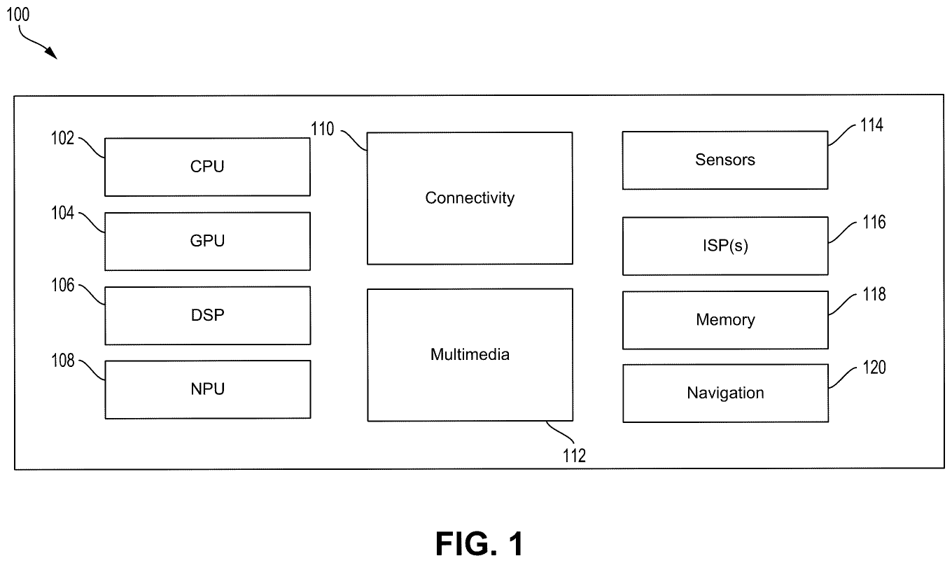

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

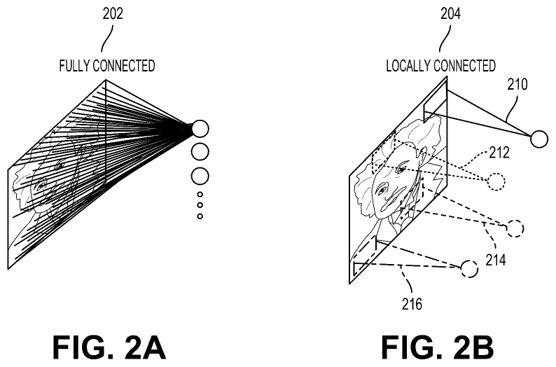

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As mentioned previously, the systems and techniques described herein can be used to perform background replacement for video data (e.g., also referred to herein as “video background replacement” and/or generating “background replaced video data”). In some examples, the systems and techniques can be used to automatically perform background replacement for video data (e.g., also referred to herein as generating “background replacement video”). In some aspects, the systems and techniques can be implemented using a mobile computing device such as a smartphone, etc. In one illustrative example, the systems and techniques can perform video background replacement based on camera pose tracking information obtained during the capture of an input video data, as will be described below.

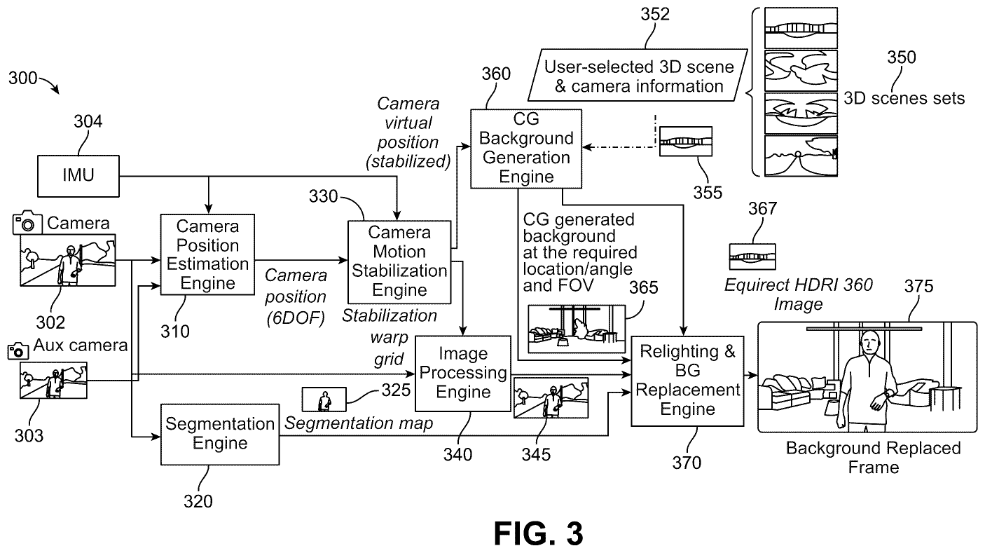

FIG. 3 is a diagram illustrating an example architecture of a background replacement image processing system 300, in accordance with some examples. In some aspects, the background replacement image processing system 300 can be used to generate a background replaced frame 375 corresponding to an input frame 302 and a 3D background replacement scene 355. The background replacement image processing system 300 can be used to process frames of image data, which can be still image frames, frames of video data, etc. As used herein, a “frame” or “frame of image data” can refer interchangeably to a still image frame and/or a video frame included in a plurality of frames of video data.

In some aspects, the input frame 302 can be obtained (e.g., captured) using a camera of a computing device used to implement the background replacement image processing system 300. For instance, input frame 302 can be obtained using a camera of a smartphone or other image capture device, mobile computing device, etc., used to implement the background replacement image processing system 300. The input frame 302 can also be referred to herein as an “input image 302.” In some cases, one or more additional (e.g., auxiliary) image frames can be obtained corresponding to the input image frame 302. For instance, one or more additional frames 303 can be captured corresponding to input frame 302, using a respective additional camera included on the same computing or image capture device used to obtain the input frame 302. In some aspects, the input frame 302 and the additional frame 303 may be captured simultaneously. In some examples, the input frame 302 and the additional frame 303 may be captured successively. Based on the distance or separation between the camera used to obtain the input frame 302 and the camera used to obtain the additional frame 303, the camera position estimation engine 310 can generate a camera position estimation (e.g., camera pose estimation) with improved accuracy.

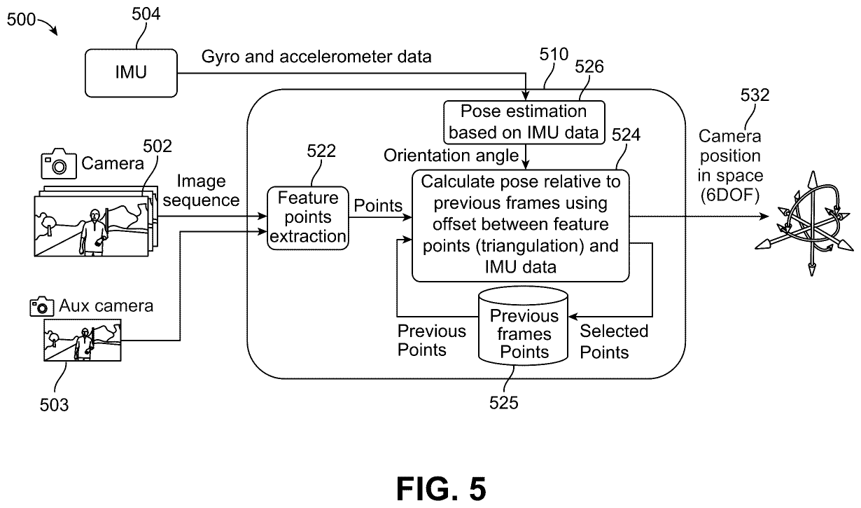

A camera position estimation engine 310 (e.g., also referred to as a “camera pose estimation engine”) can determine an estimated camera pose (e.g., 6DOF pose, etc.) corresponding to the current input image 302. For instance, the camera position estimation engine 310 can determine the estimated camera pose corresponding to the pose of the camera at the time the input image 302 was captured. In some aspects, the estimated camera pose information can be relative pose information. For instance, the estimated camera pose information for the current frame (e.g., input image 302) can be relative pose information referenced to a previous frame (e.g., also referred to as a “reference frame”). For instance, the current frame (e.g., input image 302) and the reference frame can be included in the same stream of image or video data, and the reference frame may be the first frame in the stream. In some examples, the particular frame (e.g., of a plurality of frames in the stream) used as the reference frame can be changed or updated, for instance based on accuracy or drift accumulated over time. For example, the camera position estimation engine 310 can determine and/or utilize a new or updated reference frame for the estimated camera pose when the captured scene changes (e.g., moving from one room to another), when a pre-determined or configured time period expires, etc. In one illustrative example, the camera position estimation engine 310 can determine a 6DOF camera pose estimation for the current input frame 302 based on inertial information obtained from IMU 304 or other inertial sensor(s) included in the image capture device used to implement the background replacement image processing system 300. In one illustrative example, the camera position estimation engine 310 of FIG. 3 can be the same as or similar to the camera position estimation engine 510 of FIG. 5, which will be described in greater detail below.

FIG. 5 is a diagram 500 illustrating an example of a camera position estimation engine 510 that can be the same as or similar to the camera position estimation engine 310 of FIG. 3. For instance, an IMU 504 used to obtain gyroscopic and accelerometer data (e.g., among various other types of inertial data) can be the same as or similar to the IMU 304 of FIG. 3. An input image frame 502 can be the same as or similar to the input image frame 302 of FIG. 3.

In one illustrative example, the camera position estimation engine 510 can be configured to perform a camera pose estimation 526. For instance, camera pose estimation 526 can be performed based on image data (e.g., input image frame 502) and IMU data (e.g., inertial data obtained using IMU 504). In some aspects, the IMU data obtained using IMU 504 can be utilized by the camera pose estimation 526 of the camera position estimation engine 510 to determine an accurate estimate of the camera pose at the time of capture of the input image frame 502. The camera pose can also be referred to as the angular orientation of the camera. The gyroscopic and/or accelerometer data obtained using the IMU 504 (e.g., included in the IMU data of IMU 504) can be used by the camera pose estimation 526 to determine a translational position of the camera (e.g., translation information, 2D or (x,y) position, etc.). In some examples, the gyroscopic and/or accelerometer data obtained using the IMU 504 can be used to estimate one or more of an x-direction, y-direction, and/or z-direction acceleration. Based on integration of the acceleration information in each respective direction or axis, a corresponding coarse location estimation can be determined relative to a previous time (e.g., reference frame, etc.). In some examples, a coarse location estimation based on the IMU data of IMU 504 can be refined based on location information determined using image data. For instance, the coarse location estimation determined by camera pose estimation engine 526 and using IMU 504 data can be refined based on image data analyzed by the feature points extraction engine 522. For instance, feature points extraction engine 522 can perform feature points matching between pairs of corresponding images, such as the current image frame 502 and an additional or auxiliary frame 503 corresponding to the current image frame 502. In some examples, the additional frame 503 of FIG. 5 can be the same as or similar to the additional frame 303 of FIG. 3. In some aspects, the translational position of the camera can be determined based on the motion (e.g., translation) along each of the x-, y-, and z-axes of the 3D measurement space. As noted above, the gyroscopic and/or accelerometer data obtained using the IMU 504 can additionally be used to determine ground-position information corresponding to a current translation position of the camera. For instance, ground-position information can be indicative of an orientation of the camera relative to the direction of gravitational acceleration as determined by the IMU 504. and the ground position of the camera may be the same (e.g., “translational position” may refer to “ground position,” and vice versa).

The image data (e.g., input image frame 502) can be used to track particular feature-points between frames (e.g., between frames of video data). For instance, the input image frame 502 can be provided to a feature points extraction engine 522, which can generate as output a plurality of extracted feature points corresponding to the input image frame 502. The additional image frame 503 can additionally be provided to the feature points extraction engine 522 and used to generate the plurality of extracted feature points. In some cases, the feature points extraction engine 522 can generate a first set of feature points determined for the input image frame 502 and a second set of feature points determined for the additional image frame 503, and the relative pose calculation engine 524 can perform feature point mapping between features of the input frame 502 and the additional frame 503. In some examples, the feature points extraction engine 522 can perform the mapping, and output the set of extracted features that were mapped between the input frame 502 and the additional frame 503. For example, in some cases the camera pose estimation engine 510 can be implemented as a 6DOF estimation engine. A 6DOF estimation engine can be configured to determine 6DOF position estimates using a single camera input (e.g., input frame 502) or using multiple camera inputs. For instance, multiple-camera 6DOF estimation can be performed using two camera inputs (e.g., input frame 502 and additional frame 503), four camera inputs, etc. Multiple-camera 6DOF estimation can be used to improve accuracy and/or convergence speed in determining the estimated camera pose in space information 532 (e.g., the estimated camera 6DOF information 532). For example, based on known distance information between a first camera used to obtain input frame 502 and a second camera used to obtain additional frame 503, disparity information can be determined for corresponding feature point pairs across the input frame 502 and the additional frame 503. In some aspects, the disparity of a respective feature point can be used to determine three-dimensional motion information based on using triangulation. In some aspects, the extracted feature points generated by the feature points extraction engine 522 can be provided to a relative pose calculation engine 524.

The relative pose calculation engine 524 can receive as input the extracted feature points from the feature points extraction engine 522 and the orientation angle determined by the camera pose estimation 526. In one illustrative example, the relative pose calculation engine 524 can calculate the camera pose associated with the currently processed frame (e.g., input image frame 502) based on using triangulation between the feature points tracked across multiple frames and/or between the input frame 502 and the additional frame 503. For instance, the relative pose calculation engine 524 can utilize one or more previous feature points stored in a database 525 of previous frame feature points. The database 525 can store some (or all) of the plurality of feature points determined by the feature points extraction engine 522 for one or more previous frames (e.g., frames captured and processed prior to the current input frame 502 and/or additional frame 503).

The relative pose calculation engine 524 can track specific feature points between frames, and can use triangulation to identify the current frame 502 camera pose relative to a particular previous frame. In some examples, the relative pose calculation engine 524 calculates the current frame camera pose relative to previous frames based on using one or more offsets between particular feature points (e.g., using triangulation), and further based on using the IMU 504 data and/or the initial pose estimation determined at camera pose estimation 526.

In some aspects, the previous frame feature point database 525 can be implemented as a historical database used by the relative pose calculation engine 524 to compare the extracted feature points for the current frame 502 with the extracted feature points for one or more previous frames (e.g., feature points for a current frame t can be compared with feature points for one or more of the preceding frames t−1, t−2, t−3, . . . , etc.). Based on measuring or determining the distance between matching feature points across frames (e.g., the same feature point present at different relative locations within the current input frame 502 and/or additional frame 503 and a previously processed frame from database 525), the relative pose calculation engine 524 can refine the camera pose estimate. In one illustrative example, the relative pose calculation engine 524 can refine the camera pose estimation for the current frame 502 based on fusing IMU data (e.g., from IMU 504) and current frame feature points (e.g., frame 502 and/or 503 feature points) relative to previous frames (e.g., previous frame feature points database 525). The refined camera pose estimate for the current frame 502 can be associated with an improved accuracy and consistency relative to the camera pose estimate determined at 526 using only the IMU 504 data. In some examples, the camera pose estimation refinement can be implemented based on determining the refined camera pose based on IMU pose and refinement information corresponding to the motion measured in the image feature point analysis described above. In some aspects, the camera position estimation engine 510 can implement simultaneous localization and mapping (SLAM) for generating the refined camera position estimate 532. In some aspects, an output of the camera position estimation engine 510 is an estimated camera pose in space 532, which in one illustrative example can be a refined 6DOF camera pose estimate. The refined 6DOF camera pose estimate 532 can be the same as or similar to the 6DOF camera pose estimate generated by the camera position estimation engine 310 of FIG. 3.

In one illustrative example, the 6DOF camera pose information (e.g., estimated and/or determined by the camera position estimation engine 310 of FIG. 3, the camera position estimation engine 510 of FIG. 5, etc.) can be provided to a camera motion stabilization engine 330. Based on the 6DOF camera pose information and the inertial information obtained using IMU 304, the camera motion stabilization engine 330 can determine a stabilized camera virtual position corresponding to the input image 302. In some aspects, the inertial information provided from IMU 304 to camera position estimation engine 310 can be the same as the inertial information provided from IMU 304 to camera motion stabilization engine 330. For instance, the inertial information from IMU 304 can be inertial information obtained at the time of capture of the input image 302. In some cases, the inertial information can correspond to a period or interval of time that includes the time of capture of the input image 302.

In some examples, the system 300 does not include camera motion stabilization engine 330 and camera motion stabilization is skipped or not performed. For instance, the output of camera position estimation engine 310 (e.g., a 6DOF camera pose estimate) can be provided directly to the CG background generation engine 360. In some aspects, the CG background generation engine 360 can perform CG background generation using non-stabilized image frame data (e.g., input frame 302, etc.). In some aspects, the system 300 does not include camera motion stabilization engine 330 and receives the input frame 302 as part of a stabilized image or video data from a camera or other image capture device. For instance, the camera or image capture device used to obtain the input frame 302 can be used to perform camera motion stabilization that is independent from the system 300 of FIG. 3. For example, camera motion stabilization can be implemented based on obtaining stabilized image or video data from a camera (e.g., a camera implementing in-body or on-sensor stabilization, a camera coupled to a gimbal or other external stabilization device, etc.). In examples where the system 300 does include camera motion stabilization engine 330, the image processing engine 340 can generate the processed image output 345 without using a stabilization warp grid.

In some aspects, the camera motion stabilization engine 330 can additionally be used to generate a stabilization warp grid corresponding to the input image 302. In one illustrative example, the camera motion stabilization engine 330 performs video stabilization corrections for the input image 302 (e.g., input frame of video data comprising input image 302), based on the IMU 304 inertial data. For instance, the video stabilization corrections can include one or more of removing hand-shake, vibration, or other motion; correcting for rolling-shutter; correcting for lens-distortion; etc. The stabilization warp grid can correspond to the one or more video stabilization corrections determined by the camera motion stabilization engine 330 for the input image frame 302. For instance, applying the stabilization warp grid to the input image frame 302 can produce a stabilized input image frame, based on the stabilization wrap grid warping various portions of the input image frame 302 with a direction and magnitude corresponding to the determined video stabilization corrections.

The camera motion stabilization engine 330 can additionally be used to determine a modified or refined camera pose information (e.g., can be used to modify or refine the relative camera pose estimated by the camera position estimation engine 310). For instance, the camera motion stabilization engine 330 can generate a modified camera pose information based on determining camera motion stabilization corrections. In one illustrative example, the camera motion stabilization engine 330 can generate modified camera pose information corresponding to a smooth and/or stabilized path of the camera (e.g., a shake-less motion path of the camera). The relative camera pose information after the one or more video stabilization corrections are applied is also referred to as the “camera virtual position” and/or the “stabilized camera virtual position.” The stabilized camera virtual position can be used by a CG background generation engine 360 to render a configured 3D scene 352 (e.g., of a plurality of 3D scenes 350) at the appropriate position or view corresponding to the stabilized camera virtual position. The stabilization warp grid corresponding to the input image 302 can be used to perform one or more image processing operations at an image signal processor (ISP) 340 of the image capture device used to implement the background replacement system 300 of FIG. 3.

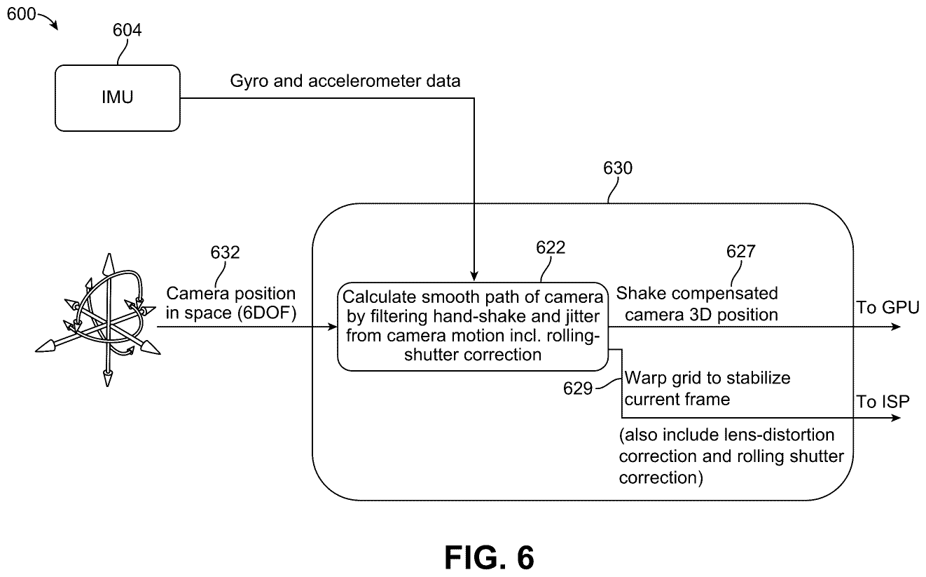

In one illustrative example, the camera motion stabilization engine 330 can be the same as or similar to the camera motion stabilization engine 630 of FIG. 6, which is described in greater detail below. FIG. 6 is a diagram 600 illustrating an example of a camera motion stabilization engine 630 that can be used with the background replacement image processing system 300 of FIG. 3.

In some aspects, the camera motion stabilization engine 630 can include a camera path correction engine 622 configured to determine a shake-compensated camera 3D position 627 and a stabilization warp grid 629. The shake-compensated camera 3D position 627 can also be referred to as a “stabilized camera virtual position,” as was described previously above. In some examples, the camera path correction engine 622 can generate the shake-compensated 3D position 627 and the stabilization warp grid 629 based on inertial data from an IMU 604 and 6DOF camera pose information 632. The IMU 604 can be the same as or similar to one or more of the IMU 304 of FIG. 3, the IMU 504 of FIG. 5, etc. In some aspects, the 6DOF camera pose information 632 can be the same as the refined 6DOF camera pose estimate 532 generated by the camera position estimation engine 510 of FIG. 5 (e.g., which may be the same as the camera position estimation engine 310 of FIG. 3).

In some examples, the camera path correction engine 622 can use the IMU 604 data (e.g., gyroscopic data, accelerometer data, and/or other inertial sensor data) to determine video stabilization correction information to stabilize or remove hand-shake or other camera movements, to correct for rolling shutter and/or lens distortion, etc. In some aspects, the video stabilization correction information can be represented in the stabilization warp grid 629 generated by the camera path correction engine 622. In some aspects, the stabilization warp grid 629 can combine the one or more video stabilization corrections with the lens-distortion correction(s) and/or rolling shutter correction(s) in a single stabilization warp grid. In some examples, the stabilization warp grid 629 can correspond to the one or more video stabilization corrections, and the lens-distortion correction(s) and/or rolling shutter correction(s) can be represented in separate outputs of corresponding warp grids.

In one illustrative example, the stabilized camera virtual position 627 (e.g., shake-compensated camera 3D position) can be output by the camera motion stabilization engine 630 and provided to a GPU of the image processing device. For instance, the stabilized camera virtual position can be provided to the CG background generation engine 360 of FIG. 3, which may be implemented by a GPU of the image processing device. The stabilization warp grid 629 can be provided from the camera motion stabilization engine 630 to an ISP of the image processing device, such as the image processing engine 340 of FIG. 3 (e.g., which may be implemented by an ISP of the image processing device).

For instance, the image processing engine 340 and/or ISP of the image processing device used to implement the background replacement system 300 of FIG. 3 can be used to process the input frames of image data (e.g., such as the currently processed image frame 302). In one illustrative example, the image processing engine 340 can process the input frame 302 using the stabilization warp grid of camera motion stabilization engine 330 (e.g., the stabilization warp grid 629 of camera motion stabilization engine 630 of FIG. 6) to apply stabilization corrections to the input frame 302. In some aspects, the image processing engine 340 can be used to process input frames of video data in combination with the corresponding stabilization warp grid generated for each respective input frame of video data. The image processing engine 340 can generate a corresponding stabilized and processed frame 345 based on applying the corresponding stabilization warp grid to each respective input frame of video data. The image processing engine 340 may also perform or apply one or more additional ISP operations included in a main ISP processing implemented by the image capture device used to implement the background replacement system 300 of FIG. 3. In some aspects, the image processing engine 340 and/or ISP of the image processing device used to implement the background replacement system 300 of FIG. 3 can perform image process operations for a subset of the plurality of pixels included in the input image frame 302. For instance, the image processing engine 340 can use the segmentation map 325 to determine the subset of pixels of input image frame 302 identifies as belonging to a foreground class or foreground object of the segmentation. In some aspects, the image processing engine 340 can perform the one or more image processing operations for the subset of pixels comprising a rectangular bounding box around the foreground object(s) of the segmentation map 325. Processing the rectangular bounding box of the foreground object(s) can reduce power consumption, latency, and/or complexity of the image processing engine 340 implementation.

The background replacement image processing system 300 of FIG. 3 includes a CG background generation engine 360, which can be used to generate a CG-generated background 365. In one illustrative example, the CG-generated background 365 can be generated as a view of or into a user-selected 3D scene 355 (e.g., a 3D scene 355 included in a plurality of 3D scenes 350). For instance, the CG-generated background 365 can be a view of or into the configured 3D scene 355, where the view of the 3D scene is determined based on (e.g., corresponds to) the stabilized camera virtual position determined by the camera motion stabilization engine 330.

In some examples, the background generation engine 360 can be included in or implemented by one or more of a graphics processing unit (GPU), neural processing unit (NPU), etc., of the image capture device used to implement the background replacement image processing system 300 of FIG. 3.

In some aspects, the CG background generation engine 360 can use the stabilized camera virtual position (e.g., generated using the camera motion stabilization engine 360) to generate a CG background 365 at a corresponding location, angle, angle-of-view (AOV), and/or field-of-view (FOV) for the currently processed frame 302. As used herein, angle-of-view (AOV) and field-of-view (FOV) may be used interchangeably to refer to the angular extent of a scene that is imaged. In some aspects, the CG background generation engine 360 can generate the CG background frame or data 365 based on a configured three-dimensional (3D) scene 355 selected for use as the replacement background in the background replaced video 375. In some aspects, the CG background generation engine 360 can use a configured 3D scene 355 that is selected based on a user input indicative of a selection from a plurality of 3D scenes 350. In some cases, the plurality of 3D scenes 350 can be previously generated and/or stored 3D scenes. In some examples, at least a portion of the plurality of 3D scenes 350 can be generated using one or more generative artificial intelligence (AI) models.

In one illustrative example, the CG background generation engine 360 can generate the replacement background image data 365 corresponding to the currently processed frame 302 based on using the stabilized camera virtual position information to obtain a frame of the 3D background scene 355. The frame or view within 3D background scene 355 can be generated with a (virtual) camera location, angle, AOV, and/or FOV, etc., that corresponds to (e.g., matches) that of the stabilized camera virtual position information calculated for the currently processed frame 302. In some aspects, the frame or view within 3D background scene 355 can additionally be generated with corresponding camera parameters such as aperture, lens characteristics, etc., that may influence the final image. For instance, the frame or view within 3D background scene 355 can be generated using a same or similar (virtual) aperture as the aperture used to obtain the input frame 302, based on the influence of aperture value on depth of field in both the rendered image (e.g., from 3D background scene 355) and the captured image (e.g., input frame 302). In some aspects, the CG background generation engine 360 can additionally generate a high dynamic range image (HDRI) image data 367 for relighting. In some examples, the HDRI image data 367 can be an HDRI360 image (e.g., a 360° image in HDRI format). In some aspects, the HDRI360 image data 367 can be an equirectangular projection of the 360° HDRI image, also referred to herein as an “equirect HDRI360 image.”

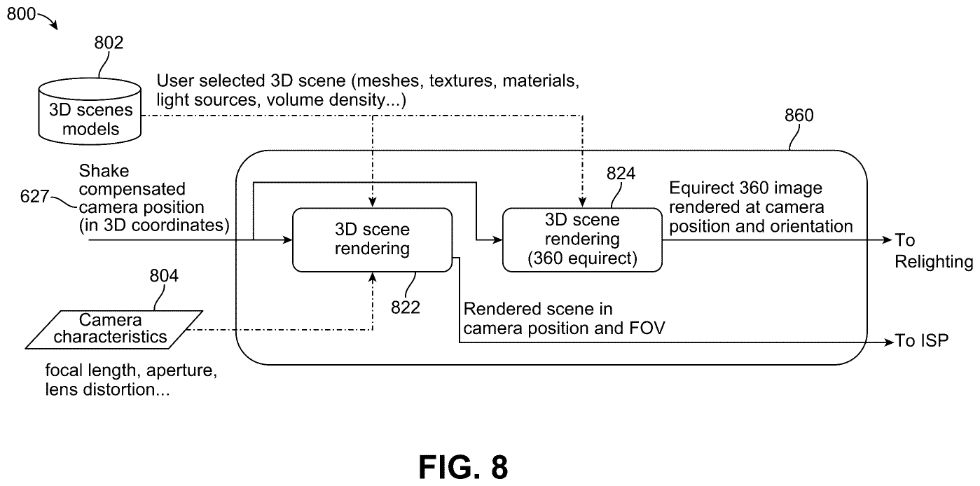

In one illustrative example, the CG background generation engine 360 of FIG. 6 can be the same as or similar to the CG background generation engine 860 of FIG. 8. For instance, FIG. 8 is a diagram 800 illustrating an example of a background generation engine 860 that can be the same as or similar to the CG background generation engine 360 of FIG. 3, in accordance with some examples. The CG background generation engine 860 can include a 3D scene rendering engine 822 and a 360° equirect 3D scene rendering engine 824.

In some aspects, the 3D scene rendering engine 822 can be used to generate (e.g., render) a 3D scene with a camera pose and AOV corresponding to the stabilized virtual camera pose 627 of FIG. 6 (e.g., which can be the same as or similar to the stabilized virtual camera pose determined by the camera motion stabilization engine 330 of FIG. 3). For instance, the 3D scene rendering engine 822 can generate a rendered 3D scene image based on a configured 3D scene model which includes meshes, textures, materials, light sources, volume density information, etc. The configured 3D scene model can be obtained from a plurality of 3D scene models 802, which may be the same as or similar to the plurality of 3D scene models 350 of FIG. 3. In some examples, the configured 3D scene model provided as input to the 3D scene rendering engine 822 can be the same as or similar to the configured 3D scene model 355 of FIG. 5. In some cases, the configured 3D scene model provided as input to the 3D scene rendering engine 822 can be a user selection from the plurality of 3D scene models 802.

The 3D scene rendering engine 822 can generate as output a rendered 3D scene in a camera pose and AOV corresponding to the shake compensated camera pose in 3D coordinates 627 (e.g., which may be the same as or similar to the stabilized virtual camera pose of FIG. 3, as noted above) and corresponding to camera characteristics information 804. The camera characteristics information 804 can correspond to or be indicative of characteristics of a camera used to obtain the input image 302 of FIG. 3 (e.g., the currently processed image frame). In some examples, the camera characteristics information 804 can include one or more of the camera focal length, camera aperture, camera lens distortion, etc., associated with the capture of the input (e.g., currently processed) image frame 302. In some examples, camera characteristics information 804 can be included in the user-selected 3D scene and camera information indication 352 of FIG. 3.

In some aspects, the rendered 3D scene generated by the 3D scene rendering engine 822 can be provided to an ISP of the image processing device. For instance, the rendered 3D scene generated as output by the 3D scene rendering engine 822 can be provided to the relighting and background replacement engine 370 of FIG. 3 as the CG-generated background replacement data 365.

In one illustrative example, the CG background generation engine 860 additionally includes the 360° equirect 3D scene rendering engine 824. The equirect 3D scene rendering engine 824 can be used to generate an equirect image (e.g., equirectangular projection of a 360° image) of the entire 3D scene, rendered around the input camera pose (e.g., location and orientation) corresponding to the shake-compensated, stabilized virtual camera pose 627. For instance, the equirect 3D scene rendering engine 824 can receive as input the same user-selected 3D scene model information (e.g., from the plurality of 3D scene models 802) as the 3D scene rendering engine 822, described above. The equirect 3D scene rendering engine 824 can additionally receive as input the same shake-compensated, stabilized virtual camera pose 627 as is utilized by the 3D scene rendering engine 822. Based on rendering an equirect 360 image rendered at the stabilized virtual camera pose 627, the equirect 3D scene rendering engine 824 does not need as input the camera characteristics information 804 that is utilized by the 3D scene rendering engine 822.

In some aspects, the equirect 360° image rendered at the camera position and orientation 627 (e.g., pose) that is generated by the equirect 3D scene rendering engine 824 can be provided to a relighting engine of the relighting and background replacement engine 370 of FIG. 3. For example, the equirect 3D scene rendering engine 824 can generate as output the equirect 360° image 367 of FIG. 3. The equirect 360° image generated as output by the equirect 3D scene rendering engine can be an equirect HDRI360 image (e.g., a high dynamic range equirectangular projection of a 360° image of the user-selected 3D scene, rendered around the input camera pose (location and orientation) 627).

In some aspects, the equirect 360° image generated as output by the equirect 3D scene rendering engine 824 can be an HDR image with high bit-width, or can be a non-HDR image. In some examples, the equirect 360° image generated as output by the equirect 3D scene rendering engine 824 can be a relatively small resolution image (e.g., such as 200 pixels in height by 400 pixels in width), as the equirect 360° image is subsequently used (e.g., by the background replacement image processing system 300 of FIG. 3) for representing the scene light color, direction, ambience, and strength, which may be represented as relatively low pixel resolution information. In some aspects, a corresponding equirect 360° image generated by the equirect 3D scene rendering engine 824 can be generated for each input frame 302 of a plurality of input frames (e.g., frames of video data) processed using the background replacement image processing system 300 of FIG. 3. For instance, the background replaced image 375 should look different in each frame as a result of a different respective camera orientation and position used to capture the respective frame. To update the appearance of the background replaced image 375 (e.g., generated as output by the background replacement image processing system 300 of FIG. 3) to correspond to changes in camera orientation and position in capturing each input image frame 302, a corresponding equirect 360° image can be rendered for each respective frame of the video data by the equirect 3D scene rendering engine 824 of the CG background generation engine 860.

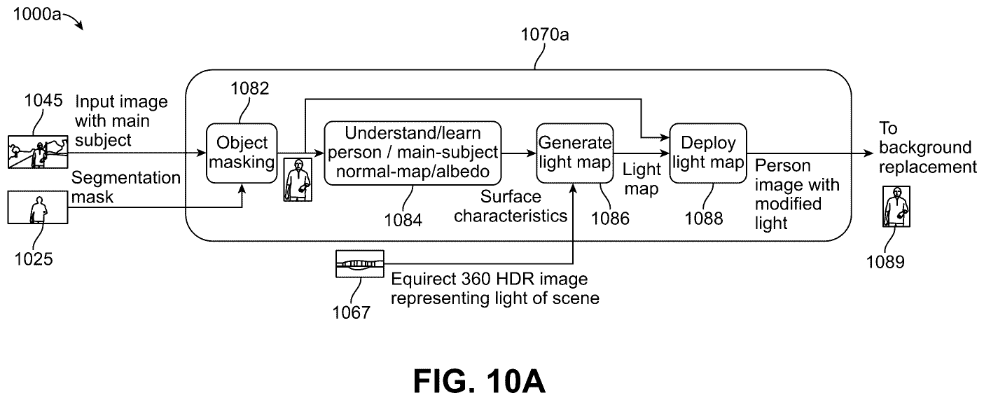

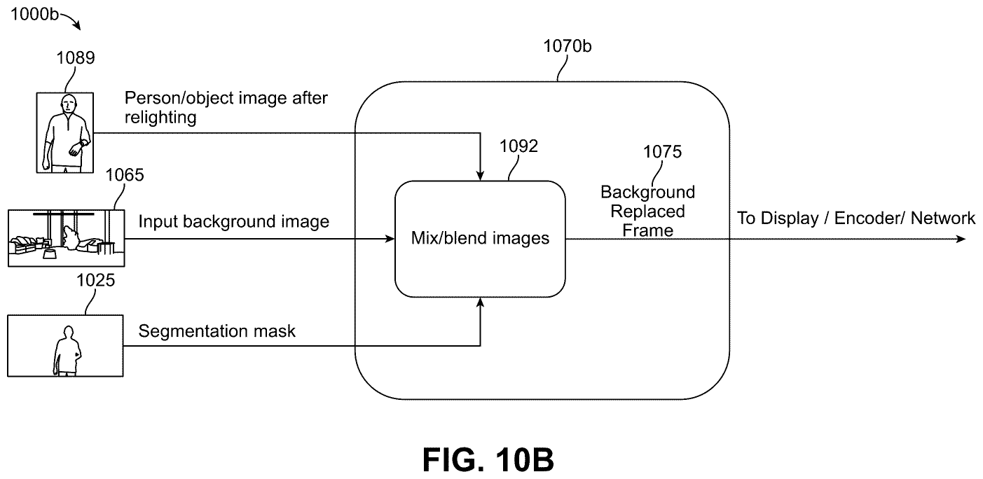

In one illustrative example, the background replacement image processing system 300 of FIG. 3 includes a relighting and background replacement engine 370. In some aspects, the relighting and background replacement engine 370 can be implemented as a single engine that includes a relighting sub-engine and background replacement sub-engine. For instance, the relighting sub-engine can be the same as or similar to the relighting engine 1070a of FIG. 10A, and the background replacement sub-engine can be the same as or similar to the background replacement engine 1070b of FIG. 10B. In some examples, the relighting and background replacement engine 370 of FIG. 3 can be implemented as a separate relighting engine (e.g., the same as or similar to the relighting engine 1070a of FIG. 10A) and a separate background replacement engine (e.g., the same as or similar to the background replacement engine 1070b of FIG. 10B).

The equirect HDRI360 image data 367 and the CG-generated background replacement data 365 from the CG background generation engine 360 (e.g., the same as or similar to the CG background generation engine 860 of FIG. 8) can be provided to the relighting and background replacement engine 370 of FIG. 3. The relighting and background replacement engine 370 can additionally receive as input a segmentation map 325 corresponding to the input image frame 302. For instance, the segmentation map 325 can be generated from the input image frame 302 using a segmentation engine 320. In some examples, the image frame 302 can be provided to the camera position estimation engine 310 in parallel with a copy of image frame 302 also being provided to the segmentation engine 320. In some examples, the segmentation engine 320 can be implemented as a machine learning network (e.g., neural network, etc.) trained to perform image segmentation. In some aspects, the segmentation engine 320 can segment the input frame 302 into at least a foreground portion and a background portion (e.g., where the background portion of the segmentation map 325 is the portion of the input image frame 302 that will be removed and replaced with the CG generated background 365 in the final output of the background replaced frame 375 for the input image frame 302).

The relighting and background replacement engine 370 can receive as input the segmentation map 325 (e.g., generated by segmentation engine 320), and the stabilized and processed image frame 345 generated by the image processing engine 340 for the input image frame 302. The relighting and background replacement engine 370 may additionally receive as input the CG-generated background (e.g., generated by CG background generation engine 360) and the equirect HDRI 360° image (e.g., also generated by CG background generation engine 360).

In one illustrative example, the relighting and background replacement engine 370 includes a relighting engine (or sub-engine) that is the same as or similar to the relighting engine 1070a of FIG. 10A. For instance, FIG. 10A is a diagram 1000a illustrating an example of a relighting engine 1070a that can be the same as or similar to the relighting and background replacement engine 370 of FIG. 3.

The relighting engine 1070a can include an object masking engine 1082 configured to separate a foreground object or subject (e.g., person) of the input image 1045 from the background of the input image 1045. In some aspects, the input image 1045 is the same as or similar to the stabilized and processed image 345 generated by the image processing engine 340 of FIG. 3. The object masking engine 1082 can separate the foreground or main subject of the input image 1045 from the background of the input image 1045 based on the segmentation mask 1025 corresponding to the input image 1045. For instance, the segmentation mask 1025 can be the same as or similar to the segmentation mask 325 of FIG. 3.

The output of the object masking engine 1082 can be a foreground or main subject portion of the input image 1045, with the background removed based on the segmentation mask 1025. A map learning engine 1084 can be used to learn 3D characteristics of the main subject (e.g., foreground or person of the input image 1045), based on the segmented foreground portion generated as output by the object masking engine 1082. For instance, the learned 3D characteristics of the main subject can include one or more of a normal map of the face of the main subject, a normal map of the body of the main subject, and albedo map of the main subject, etc.

In some cases, the map learning engine 1084 can generate as output information indicative of learned surface characteristics of the main subject (e.g., normal maps, albedo maps, etc.). The learned surface characteristics determined by map learning engine 1084 can be provided as input to a light map engine 1086, which can be configured to generate a light map corresponding to the learned surface characteristics from map learning engine 1084 and the equirect 360° HDR image 1067 representing the lighting of the 3D scene for background replacement. In some examples, the equirect 360° HDR image 1067 can be the same as or similar to the HDRI360 image data 367 of FIG. 3 and/or the equirect 360° image generated by the equirect 3D scene rendering engine 824 of FIG. 8.

Using the equirect 360° HDR image 1067 light image, the light map engine 1086 can calculate the surrounding light influence on the main subject or main foreground object's surface (e.g., can calculate the influence of the light represented in equirect 360° HDR image 1067 on the main subject surface represented in the learned surface characteristics from map learning engine 1084). The light map generated as output by the light map engine 1086 can be indicative of the surrounding light influence on the main subject object surface, where the light map is generated to convert the current lighting of the person (e.g., main subject of input image 1045) to the lighting style or characteristics of the 3D scene (e.g., the 3D scene corresponding to the equirect 360° HDR image 1067).

A light map deployment engine 1088 can receive the light map from the light map engine 1086 and combine the light map with the masked foreground portion of input image 1045 (e.g., from object masking engine 1082). In one illustrative example, the light map deployment engine 1088 can modify the tone and/or color of the person (e.g., main subject) represented in the input image 1045 and the masked input image output of the object masking engine 1082. For instance, the light map deployment engine 1088 can modify the tone and/or color of the main subject (or the tone and/or color of portions of the main subject) based on the lighting information included in the light map (e.g., light map generated by light map engine 1086). In some aspects, the light map generated by the light map engine 1086 can be implemented as a gain map, and the light map deployment engine 1088 can be configured as a gain map deployment engine.

The light map deployment engine 1088 can generate as output an image of the person (e.g., main subject) of the input image 1045 with modified lighting characteristics (e.g., with modified light rendering, updated based on and corresponding to the light map generated by light map engine 1086). The modified lighting image 1089 can be provided from the relighting engine 1070a to the background replacement engine 1070b of FIG. 10B.

For instance, FIG. 10B is a diagram 1000b illustrating an example of a background replacement engine 1070b that can receive as input the segmented foreground image after relighting 1089. In one illustrative example, the background replacement engine 1070b of FIG. 10B can receive the segmented foreground image after relighting 1089 from the relighting engine 1070a of FIG. 10A.

The background replacement engine 1070b can include an image blending engine 1092 that is configured to generate as output a background replaced frame 1075, which may be the same as or similar to the background replaced frame 375 of FIG. 3. In one illustrative example, the image blending engine 1092 can generate the background replaced frame 1075 based on the segmented foreground image after relighting 1089 (e.g., generated by the relighting engine 1070a of FIG. 10A), an input background replacement image 1065 (e.g., the same as or similar to the background replacement image 365 of FIG. 3 and/or the background replacement image generated by the 3D scene rendering engine 822 of FIG. 8, etc.), and the segmentation mask 1025 (e.g., which may be the same as or similar to the segmentation mask 325 of FIG. 3). In some cases, the object after relighting (e.g., segmented foreground image after relighting 1089) can include some (or all) of the information of segmentation mask 1025 as an alpha map. For instance, the object after relighting 1089 can be a YUVA or RGBA image, where ‘A’ represents the alpha channel used to indicate transparency information for each respective pixel of the image. In some examples, different segmented objects and/or segment classifications of the segmentation mask 1025 can be represented as different respective transparency values (e.g., different alpha values) in the alpha map and/or alpha channel corresponding to the object after relighting 1089 YUVA or RGBA image data.

In some aspects, the background replacement engine 1070b can use the image blending engine (e.g., image blending sub-engine) 1092 to generate a final output image (e.g., background replaced frame 1075) that mixes between the foreground image portion after relighting (e.g., the relighted foreground portion 1089) and the 3D generated background replacement scene from the GPU (e.g., the 3D generated background replacement scene 1065 from the background generation engine 360 of FIG. 3 and/or background generation engine 860 of FIG. 8). In one illustrative example, the image blending engine 1092 can use the segmentation mask 1025 to differentiate between and/or separate the pixels of the person/object image after relighting 1089 from the background.

For instance, the image blending engine 1092 can use the segmentation mask 1025 corresponding to the person/main subject to determine which pixels of the final output background replaced image 1075 are obtained from the 3D replacement background 1065, and which pixels of the final output background replaced image 1075 are obtained from the relighting output 1089. In some aspects, the image blending engine 1092 can feather the transition between foreground and background portions of the segmentation mask 1025 based don generating pixels values that are a combination of the same respective pixel position values in the 3D replacement background 1065 and in the relighting output 1089. In some examples, the image blending engine 1092 can utilize various other image processing and/or image blending techniques to feather the transitions between the foreground and background portions of the segmentation mask 1025, to make the fusion of the two within the final output background replaced image 1075 appear more realistic.

In some aspects, the systems and techniques can be used to perform background replacement image processing using a configured or selected 3D scene to generate a rendered view of the replacement background corresponding to the calculated stabilized virtual camera pose of the current image frame (e.g., as described above with respect to background replacement image processing system 300 of FIG. 3).

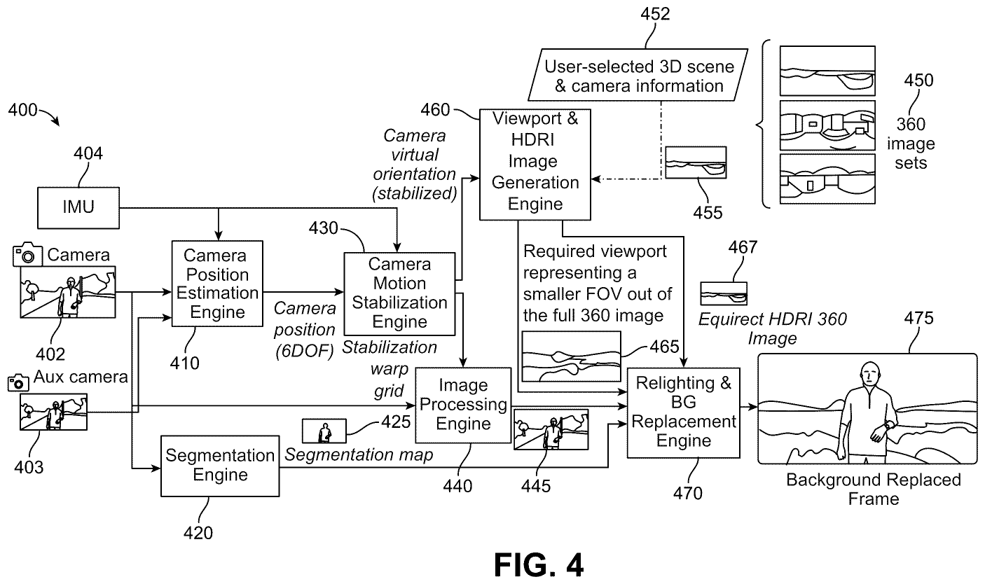

In one illustrative example, the systems and techniques can be used to perform background replacement image processing using a configured or selected 360° image to generate a rendered view of the replacement background corresponding to the calculated stabilized virtual camera pose of the current image frame. For instance, FIG. 4 is a diagram illustrating an example architecture of a background replacement image processing system 400 that utilizes a 360° image to perform background replacement.

An IMU 404 can be the same as or similar to the IMU 304 of FIG. 3. An input image frame 402 can be the same as or similar to the input image frame 302 of FIG. 3. An additional image frame 403 can be the same as or similar to the additional image frame 303 of FIG. 3. A camera position estimation engine 410 can be the same as or similar to the camera position estimation engine 310 of FIG. 3 and/or the camera position estimation engine 510 of FIG. 5. A segmentation engine 420 can be the same as or similar to the segmentation engine 320 of FIG. 3. A segmentation map 425 can be the same as or similar to the segmentation map 325 of FIG. 3.

A camera motion stabilization engine 430 may be the same as or similar to the camera motion stabilization engine 330 of FIG. 3. For instance, the camera motion stabilization engine 330 of FIG. 3 can utilize camera pose information that includes a rotational component and a translational component; the camera motion stabilization engine 430 of FIG. 4 can utilize camera pose (e.g., orientation) information that includes the rotational component and does not include the translational component.

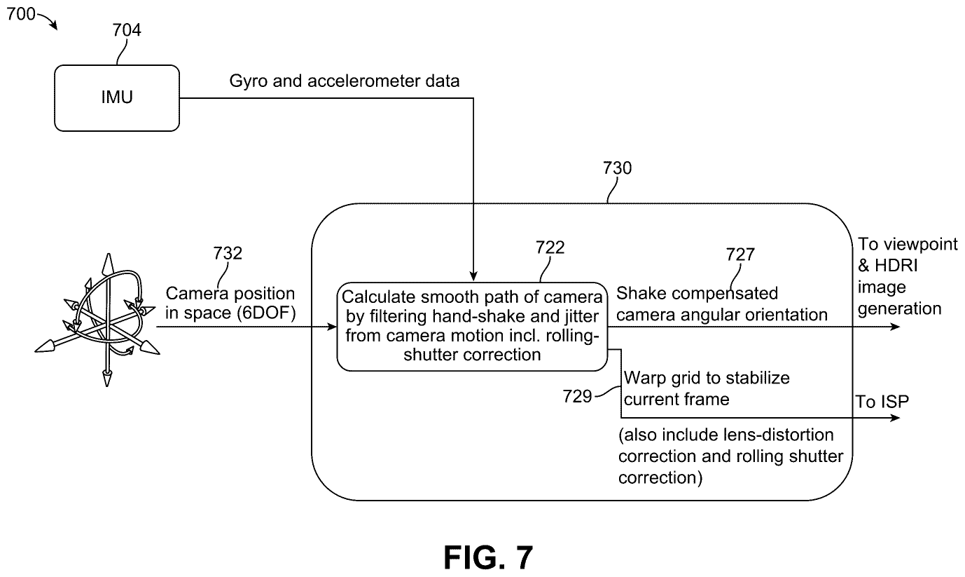

In one illustrative example, the camera motion stabilization engine 430 can be the same as or similar to the camera motion stabilization engine 730 of FIG. 7. For instance, FIG. 7 is a diagram 700 illustrating an example camera motion stabilization engine 730 that can be the same as and/or can be used to implement the camera motion stabilization engine 430. The IMU 704 can be the same as or similar to the IMU 404 of FIG. 4. The 6DOF camera pose 732 can be the same as or similar to the 6DOF camera pose estimation generated using the camera position estimation engine 410 of FIG. 4 (e.g., the 6DOF camera position estimation 532 of FIG. 5). The camera motion stabilization engine 730 can include a camera path correction engine 722 that can be the same as or similar to the camera path correction engine 622 of FIG. 6. The camera path correction engine 722 can be used to calculate a smooth path of the camera by filtering hand-shake and jitter movement from the camera motion, and may include applying rolling-shutter correction. The camera path correction engine 722 can generate or determine a shake compensated camera angular orientation 727. In some examples, the camera angular orientation 727 can be the same as or similar to angular orientation information that is included in the shake-compensated camera 3D position 627 of FIG. 6 (e.g., camera angular orientation information, such as the camera angular orientation 727 of FIG. 7, can be a subset of camera pose information such as the camera pose information 627 of FIG. 6). The camera path correction engine 722 can additionally generate or determine a stabilization warp grid 729 that can be the same as or similar to the stabilization warp grid 629 of FIG. 6.

In some cases, the camera motion stabilization engine 730 can be configured for a non-stabilized flow. For instance, the camera motion stabilization engine 730 can be configured to provide as output (e.g., to viewport and HDRI image generation engine 460 of FIG. 4) 6DOF angular data only, and in the non-stabilized flow configuration does not provide or output a shake-compensated camera angular orientation. In some examples, the camera motion stabilization engine 730 does not receive the 6DOF camera pose information 732 as input, and can be configured to generate an orientation angle estimate based only on IMU data (e.g., gyroscopic and/or accelerometer data) from IMU 704. In the non-stabilized flow configuration, camera motion stabilization engine 730 does not provide an output (e.g., warp grid 729) to the ISP or image processing engine 440 of FIG. 4

The stabilization warp grid 729 can be provided from the camera motion stabilization engine 730 to an image processing engine 440 of the system 400 of FIG. 4 (e.g., which can be the same as or similar to the image processing engine 340 of FIG. 3). The shake-compensated camera angular orientation 727 can be provided from the camera motion stabilization engine 730 to a viewport and HDRI image generation engine (e.g., such as the viewport and HDRI image generation engine 460 of FIG. 4).

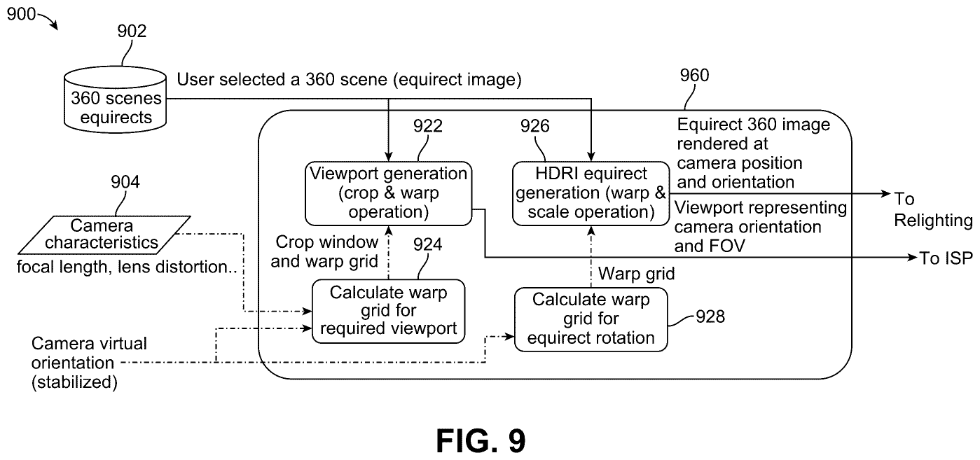

In some aspects, the viewport and HDRI image generation engine 460 can be the same as or similar to the viewport and HDRI image generation engine 960 of FIG. 9. For instance, FIG. 9 is a diagram 900 illustrating an example viewport and HDRI image generation engine 960 that can be the same as and/or can be used to implement the viewport and HDRI image generation engine 460 of FIG. 4. The viewport and HDRI image generation engine 960 can obtain a configured or user-selected 360° scene from a plurality of 360° scenes 902, which can be the same as or similar to the plurality of 360° scenes 450 of FIG. 4. Camera characteristics information 904 can be the same as or similar to the camera characteristics information 804 of FIG. 8, and/or can be included in the user scene selection and camera information 452 of FIG. 4. In some aspects, camera characteristics information 904 can be a subset of camera characteristics information 804 of FIG. 8. For instance, the camera characteristics information 804 of FIG. 8 can include camera aperture information used to perform depth-of-field rendering for the 3D background scene rendering; in some cases, the camera characteristics information 904 of FIG. 9 may not include camera aperture information, based on the 360° images lacking the 3D information needed to apply a variable depth-of-field rendering effect.

A stabilized camera virtual orientation can be provided as input to the viewport and HDRI image generation engine 960, and can be the same as or similar to the stabilized camera virtual orientation determined using the camera motion stabilization engine 430 of FIG. 4 (e.g., which can be the same as the shake-compensated camera angular orientation 727 of FIG. 7).

The viewport and HDRI image generation engine 960 can include a viewport generation engine 922 and an HDRI equirect generation engine 926. The viewport generation engine 922 can be configured to perform one or more crop and warp operations to generate a viewport image representing the current camera orientation and AOV for the currently processed input image frame 402. In one illustrative example, the viewport generation engine 922 can be used to generate the viewport 465 of FIG. 4. For instance, the viewport 465 can be generated based on a selected 360° equirect image from the database 902 of 360° equirect images, a required camera orientation (e.g., the 3D nature of a 360° image is not changed during processing, and only camera orientation may be needed), and the camera characteristics (e.g., focal length). In some aspects, the viewport generation engine 922 can utilize a warp grid calculated by a viewport warp grid engine 924. The viewport generation engine 922 can receive the calculated warp grid for the viewport, from the viewport warp grid engine 924, and can crop a window out of the 360° equirect image from database 902 and apply the warp grid to generate as output the viewport 465 representing camera orientation and AOV from the 360° image.

The HDRI equirect generation engine 926 can be configured to perform one or more warp or scale operations to generate an HDRI equirect 360° image rendered at the camera position and orientation (e.g., camera pose) for the currently processed frame (e.g., represented by the input stabilized camera virtual orientation provided to the viewport and HDRI image generation engine 960). For instance, the HDRI equirect generation engine 926 can be used to generate the equirect HDRI 360° image 467 of FIG. 4. An equirect warp grid engine 926 can use the stabilized camera virtual orientation information provided to the viewport and HDRI image generation engine 960 to calculate a warp grid for equirect rotation. The warp grid for equirect rotation can be provided to the HDRI equirect generation engine 926, which can apply one of or more warp and scale operations to generate the equirect 360° image 467 of FIG. 4. The output equirect 360° image from HDRI equirect generation engine 926 can be provided to the relighting and background replacement engine 470 of FIG. 4.

In the example 360° image-based background replacement image processing system 400 of FIG. 4, the remaining components can be the same as or similar to the equivalent or corresponding components in the example 3D scene-based background image processing system 300 of FIG. 3. For example, the image processing engine 440 can be the same as or similar to the image processing engine 340 of FIG. 3. The stabilized and processed image 445 can be the same as or similar to the stabilized and processed image 345 of FIG. 3. The relighting and background replacement engine 470 can be the same as or similar to the relighting and background replacement engine 370 of FIG. 3. The background replaced frame 475 of FIG. 4 can be similar to the background replaced frame 375 of FIG. 3, with the background replaced frame 475 of FIG. 4 utilizing background replacement data generated from a 360° image 455 and the background replaced frame 375 of FIG. 3 utilizing background replacement data generated from a 3D scene 355.

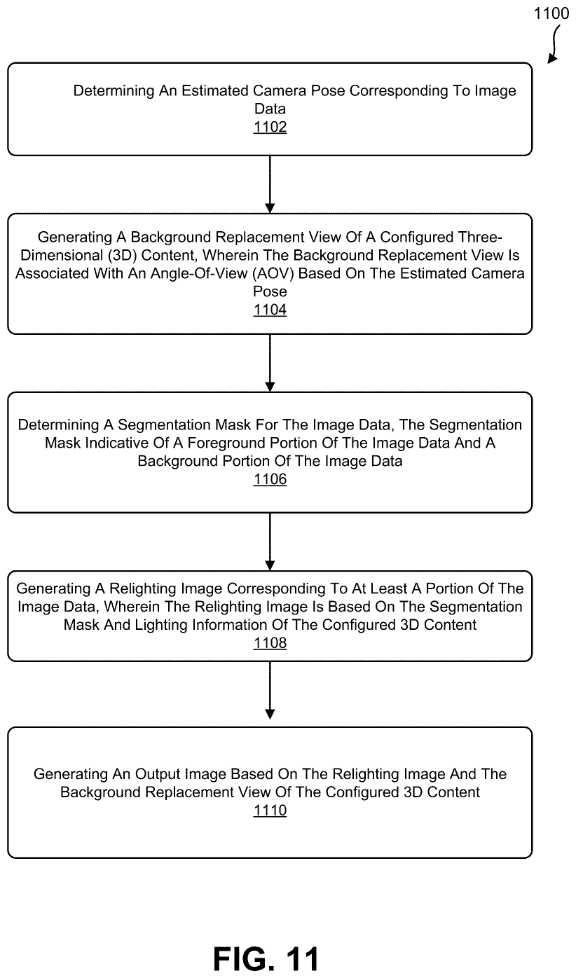

FIG. 11 is a flowchart illustrating an example of a process 1100 for processing image and/or video data. In some examples, the process 1100 can be performed by a camera, an image capture device including one or more cameras, a mobile computing device, a user computing device, a user equipment (UE), a smartphone, etc. At block 1102, the process 1100 includes determining an estimated camera pose corresponding to image data. For instance, the estimated camera pose can be determined for an image capture device used to capture the image data. In some examples, the image data is a frame of video data included in a plurality of frames of video data. In some cases, the estimated camera pose comprises an estimated 6 degrees-of-freedom (6DOF) pose of a camera used to capture the image data, at a time of capture of the image data.

For instance, the estimated camera pose can be the same as or similar to one or more of the respective 6DOF camera pose estimates determined by the camera position estimation engine 310 of FIG. 3, the camera position estimation engine 410 of FIG. 4, etc. In some examples, the estimated camera pose can be the same as or similar to the 6DOF camera pose estimate 532 of FIG. 5, the 6DOF camera pose estimate 632 of FIG. 6, the 6DOF camera pose estimate 732 of FIG. 7, etc. In some cases, the estimated camera pose can be determined using the system 500 of FIG. 5.

At block 1104, the process 1100 includes generating a background replacement view of a configured three-dimensional (3D) content, wherein the background replacement view is associated with an angle-of-view (AOV) based on the estimated camera pose.

For instance, the background replacement view can be the same as or similar to the CG generated background 365 generated using the CG background generation engine 360 of FIG. 6. In some examples, the background replacement view can be the same as or similar to the viewport 465 generated using the viewport and HDRI image generation engine 460 of FIG. 4. In some examples, the background replacement view can be generated using the system 800 and/or background replacement engine 860 of FIG. 8. In some cases, the background replacement view can be generated using the system 900 and/or background replacement engine 900 of FIG. 9.

In some cases, camera motion stabilization can be performed to generate a stabilized camera pose. For instance, camera motion stabilization can be performed using the camera motion stabilization engine 330 of FIG. 3, the camera motion stabilization engine 430 of FIG. 4, the camera motion stabilization engine 630 of FIG. 6, the camera motion stabilization engine 730 of FIG. 7, etc. In some aspects, the stabilized camera pose is based on one or more of the estimated camera pose or inertial sensor data corresponding to an image capture device used to obtain the image data. For instance, the inertial sensor data can be IMU data obtained from an IMU the same as or similar to one or more of the IMU 304 of FIG. 3, the IMU 404 of FIG. 4, the IMU 504 of FIG. 5, the IMU 604 of FIG. 6, the IMU 704 of FIG. 7, etc. In some cases, camera motion stabilization can be performed to generate a stabilization warp grid corresponding to one or more stabilization corrections determined for the image data. For instance, the stabilization warp grid can be the same as or similar to one or more of the stabilization warp grid 629 of FIG. 6 and/or the stabilization warp grid 729 of FIG. 7, etc.

In some examples, the background replacement view comprises a view of the configured 3D content rendered using an AOV corresponding to the stabilized camera pose. In some cases, the configured 3D content is a computer-generated (CG) 3D model of a scene selected from a plurality of CG 3D models of scenes. For instance, the configured 3D content can be the same as or similar to the CG 3D model 355 of FIG. 3, selected form the plurality of CG 3D models of scenes 350 of FIG. 3. In some cases, the 3D model of the scene is generated using a same image capture device used to obtain the image data. In some examples, the background replacement view of the CG 3D scene is generated using an image capture device used to obtain the image data. In some cases, the background replacement view comprises a view of a portion of the CG 3D scene, wherein the view of the portion of the CG 3D scene is associated with an AOV corresponding to the image data and the estimated camera pose.

In some cases, the configured 3D content can be based on an additional image captured using a same image capture device used to obtain the image data. For instance, the image data can be a first image obtained using a first camera of the image capture device, and the configured 3D content can be a 360° image obtained using at least a second camera of the image capture device. For instance, the additional image (e.g., 360° image) can be the same as or similar to the 360° image 455 of FIG. 4, selected from the plurality of 360° images 450 of FIG. 4. In some cases, the image data and the additional image are captured using a same camera of the image capture device. In some examples, the image data is captured using a first camera of the image capture device, and the additional image is captured using a second camera of the image capture device.

In some examples, the background replacement view comprises a viewport in the additional image. For instance, the background replacement view can be a viewport the same as or similar to the viewport 465 of FIG. 4. The viewport can be generated by a viewport and HDRI image generation engine the same as or similar to the viewport and HDRI image generation engine 460 of FIG. 4. In some cases, the viewport can be the same as or similar to a viewport generated by the viewport generation engine 922 of FIG. 9. In some examples, an AOV of the viewport is a subset of an AOV of the additional image. For instance, the AOV of the viewport can determined based on camera intrinsic information associated with the image capture device.

At block 1106, the process 1100 includes determining a segmentation mask for the image data, the segmentation mask indicative of a foreground portion of the image data and a background portion of the image data. For instance, the segmentation mask can be the same as or similar to the segmentation mask (e.g., segmentation map) 325 of FIG. 3, the segmentation mask 425 of FIG. 4, the segmentation mask 1025 of FIG. 10A, the segmentation mask 1025 of FIG. 10B, etc. In some examples, the segmentation mask can be generated using a segmentation neural network, which may be included in a segmentation engine the same as or similar to the segmentation engine 320 of FIG. 3, the segmentation engine 420 of FIG. 4, etc.

At block 1108, the process 1100 includes generating a relighting image corresponding to at least a portion of the image data, wherein the relighting image is based on the segmentation mask and lighting information of the configured 3D content. For example, the relighting image can be generated using the relighting and background replacement engine 370 of FIG. 3, the relighting and background replacement engine 470 of FIG. 4, the relighting engine 1070a of FIG. 10A, etc. In some cases, the relighting image can be the same as or similar to the relighting image 1089 of FIG. 10A and FIG. 10B.

In some cases, one or more stabilization corrections are applied to the image data, based on combining the stabilization warp grid and the image data to generate a stabilized image data. The relighting image may be generated based on combining at least a portion of the stabilized image data and the lighting information. For instance, the relighting image can be generated based on combining the foreground portion of the stabilized image data 1045 of FIG. 10A with the lighting information of the equirect image 1067 of FIG. 10A. The foreground portion of the stabilized image data 1045 can be determined based on the segmentation mask (e.g., segmentation mask 1025 of FIG. 10A, etc.).

In some aspects, the lighting information is included in an equirectangular projection of the configured 3D content. For instance, the lighting information can be included in the equirect image 367 of FIG. 3, the equirect image 467 of FIG. 4, the equirect image generated by the equirect rendering engine 824 of FIG. 8, the equirect image generated by the equirect rendering engine 926 of FIG. 9, the equirect image 1067 of FIG. 10A, etc.

At block 1110, the process 1100 includes generating an output image based on the relighting image and the background replacement view of the configured 3D content. For instance, the output image can be the same as or similar to the background replaced frame 375 of FIG. 3, the background replaced frame 475 of FIG. 4, and/or the background replaced frame 1075 of FIG. 10B. In some examples, the output image can be generated using the relighting and background replacement engine 370 of FIG. 3, the relighting and background replacement engine 470 of FIG. 4, the background replacement engine 1070b of FIG. 10B, etc. For example, a foreground portion of the output image can be generated to comprise pixel data included in the relighting image (e.g., the foreground portion of background replaced frame 1075 of FIG. 10B can comprise pixel data included in the relighting image 1089 of FIG. 10B). A background portion of the output image can be generated to comprise pixel data included in the background replacement view of the configured 3D content (e.g., the background portion of background replaced frame 10785 of FIG. 10B can comprise pixel data included in the background replacement view of the configured 3D content 1065 of FIG. 10B. The background and foreground portions can be determined based on the segmentation mask (e.g., segmentation mask 1025 of FIG. 10B) for the image data.

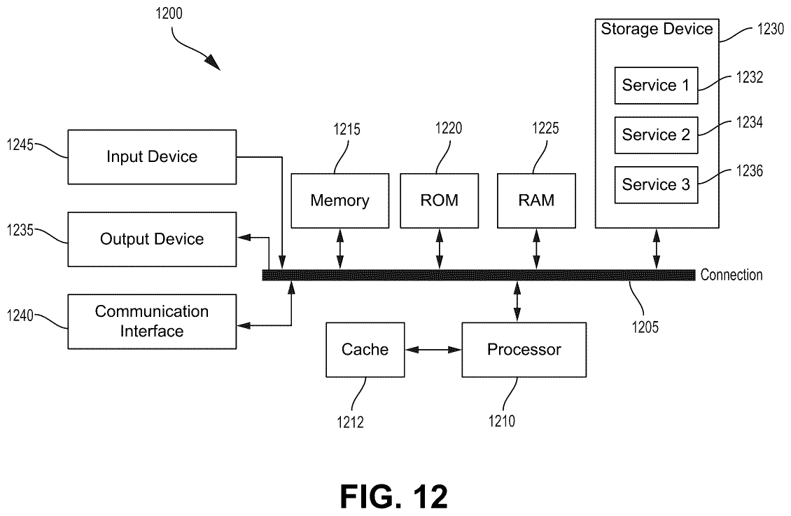

In some examples, the processes described herein (e.g., process 1100 and/or any other process described herein) may be performed by a computing device, apparatus, or system. In one example, the process 1100 can be performed by a computing device or system having the computing device architecture 1200 of FIG. 12. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 1100 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1100 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 illustrates an example computing device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 1200 can implement the system of FIG. 5. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random-access memory (RAM) 1225, to processor 1210.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other engines can control or be configured to control processor 1210 to perform various actions. Other computing device memory 1215 may be available for use as well. Memory 1215 can include multiple different types of memory with different performance characteristics. Processor 1210 can include any general-purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing device architecture 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules or engines are contemplated. Storage device 1230 can be connected to the computing device connection 1205. In one aspect, a hardware module that performs a particular function can include the software component stored in a computer-readable medium in connection with the necessary hardware components, such as processor 1210, connection 1205, output device 1235, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects or examples. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that aspects and examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects and examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects and examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, engines, circuits, and algorithm steps described in connection with the aspects and examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: determining an estimated camera pose corresponding to image data; generating a background replacement view of a configured three-dimensional (3D) content, wherein the background replacement view is associated with an angle-of-view (AOV) based on the estimated camera pose; determining a segmentation mask for the image data, the segmentation mask indicative of a foreground portion of the image data and a background portion of the image data; generating a relighting image corresponding to at least a portion of the image data, wherein the relighting image is based on the segmentation mask and lighting information of the configured 3D content; and generating an output image based on the relighting image and the background replacement view of the configured 3D content.

Aspect 2. The method of Aspect 1, wherein: a foreground portion of the output image comprises pixel data included in the relighting image; and a background portion of the output image comprises pixel data included in the background replacement view of the configured 3D content.

Aspect 3. The method of any of Aspects 1 to 2, further comprising performing camera motion stabilization to generate: a stabilized camera pose, the stabilized camera pose based on one or more of the estimated camera pose or inertial sensor data corresponding to an image capture device used to obtain the image data; and a stabilization warp grid corresponding to one or more stabilization corrections determined for the image data.

Aspect 4. The method of Aspect 3, wherein the background replacement view comprises a view of the configured 3D content rendered using an AOV corresponding to the stabilized camera pose.

Aspect 5. The method of any of Aspects 3 to 4, further comprising: applying the one or more stabilization corrections to the image data, based on combining the stabilization warp grid and the image data to generate a stabilized image data; and generating the relighting image based on combining at least a portion of the stabilized image data and the lighting information.

Aspect 6. The method of any of Aspects 1 to 5, wherein: the configured 3D content comprises a 3D model of a scene; the estimated camera pose includes a camera position and a camera orientation; and the background replacement view comprises a view of the 3D model of the scene rendered using an AOV corresponding to the camera position and the camera orientation.

Aspect 7. The method of any of Aspects 1 to 6, wherein: the configured 3D content comprises a 360° image of a scene; the estimated camera pose includes a camera orientation; and the background replacement view comprises a viewport of the 360° image of the scene, the viewport having an AOV corresponding to the camera orientation.

Aspect 8. The method of any of Aspects 1 to 7, wherein the image data is a frame of video data included in a plurality of frames of video data.

Aspect 9. The method of any of Aspects 1 to 8, wherein the lighting information is included in an equirectangular projection of the configured 3D content.

Aspect 10. The method of any of Aspects 1 to 9, wherein the lighting information comprises scene lighting information associated with a scene represented in the 3D content.

Aspect 11. The method of any of Aspects 1 to 10, wherein generating the relighting image comprises: masking out a background portion of the image data based on applying the segmentation mask to the image data; and processing the foreground portion of the image data using the lighting information of the configured 3D content.

Aspect 12. The method of Aspect 11, wherein: a foreground portion of the output image comprises relighting pixel data of the relighting output image, each pixel of the relighting pixel data corresponding to a respective pixel of the image data; and one or more pixels of the relighting pixel data represents modified tone or color information relative to the corresponding respective pixel of the image data, the modified tone or color information based on the light map.

Aspect 13. The method of any of Aspects 11 to 12, wherein processing the foreground portion of the image data using the lighting information comprises: determining a light map for the foreground portion of the image data based on learning three-dimensional surface characteristics of the foreground portion, the three-dimensional surface characteristics including at least one of a normal map or an albedo map; and modifying one or more of a tone or color of the foreground portion of the image data to generate the relighting image, based on applying the light map to the foreground portion of the image data.

Aspect 14. The method of any of Aspects 1 to 13, wherein the estimated camera pose comprises an estimated 6 degrees-of-freedom (6DOF) pose of a camera used to capture the image data, at a time of capture of the image data.

Aspect 15. The method of any of Aspects 1 to 14, wherein the configured 3D content is a computer-generated (CG) 3D model of a scene selected from a plurality of CG 3D models of scenes.

Aspect 16. The method of Aspect 15, wherein the 3D model of the scene is generated using one or more generative artificial intelligence (AI) models.

Aspect 17. The method of any of Aspects 15 to 16, wherein the 3D model of the scene is generated using a same image capture device used to obtain the image data.

Aspect 18. The method of any of Aspects 15 to 17, wherein the lighting information comprises scene lighting information associated with rendering the CG 3D scene.

Aspect 19. The method of any of Aspects 15 to 18, wherein the background replacement view of the CG 3D scene is generated using an image capture device used to obtain the image data.

Aspect 20. The method of any of Aspects 16 to 19, wherein: the background replacement view comprises a view of a portion of the CG 3D scene, wherein the view of the portion of the CG 3D scene is associated with an AOV corresponding to the image data and the estimated camera pose.

Aspect 21. The method of any of Aspects 15 to 20, wherein a background replacement view AOV is matched to the AOV corresponding to the image data and the estimated camera pose based on camera intrinsic information associated with an image capture device.

Aspect 22. The method of any of Aspects 1 to 21, wherein the configured 3D content is a 360° image selected from a plurality of 360° images.

Aspect 23. The method of any of Aspects 1 to 22, wherein the configured 3D content is based on an additional image captured using a same image capture device used to obtain the image data.

Aspect 24. The method of Aspect 23, wherein the image data and the additional image are captured using a same camera of the image capture device.

Aspect 25. The method of any of Aspects 23 to 24, wherein the image data is captured using a first camera of the image capture device, and wherein the additional image is captured using a second camera of the image capture device.

Aspect 26. The method of any of Aspects 23 to 25, wherein: the background replacement view comprises a viewport in the additional image, wherein an AOV of the viewport is a subset of an AOV of the additional image; and the AOV of the viewport is determined based on camera intrinsic information associated with the image capture device.

Aspect 27. The method of any of Aspects 1 to 26, wherein the estimated camera pose is determined based on inertial sensor data corresponding to an image capture device used to obtain the image data

Aspect 28. The method of Aspect 1, wherein the HDR image indicative of lighting information comprises an HDR 360° image of the configured 3D content.

Aspect 29. An apparatus for processing image data, comprising: at least one memory; and at least one processor coupled to the at least one memory, the at least one processor configured to: determine an estimated camera pose corresponding to image data; generate a background replacement view of a configured three-dimensional (3D) content, wherein the background replacement view is associated with an angle-of-view (AOV) based on the estimated camera pose; determine a segmentation mask for the image data, the segmentation mask indicative of a foreground portion of the image data and a background portion of the image data; generate a relighting image corresponding to at least a portion of the image data, wherein the relighting image is based on the segmentation mask and lighting information of the configured 3D content; and generate an output image based on the relighting image and the background replacement view of the configured 3D content.

Aspect 30. The apparatus of Aspect 29, wherein: a foreground portion of the output image comprises pixel data included in the relighting image; and a background portion of the output image comprises pixel data included in the background replacement view of the configured 3D content.

Aspect 31. The apparatus of any of Aspects 29 to 30, wherein the at least one processor is further configured to perform camera motion stabilization to generate: a stabilized camera pose, the stabilized camera pose based on one or more of the estimated camera pose or inertial sensor data corresponding to an image capture device used to obtain the image data; and a stabilization warp grid corresponding to one or more stabilization corrections determined for the image data.

Aspect 32. The apparatus of Aspect 31, wherein the background replacement view comprises a view of the configured 3D content rendered using an AOV corresponding to the stabilized camera pose.

Aspect 33. The apparatus of any of Aspects 31 to 32, wherein the at least one processor is further configured to: apply the one or more stabilization corrections to the image data, based on combining the stabilization warp grid and the image data to generate a stabilized image data; and generate the relighting image based on combining at least a portion of the stabilized image data and the lighting information.

Aspect 34. The apparatus of any of Aspects 29 to 33, wherein: the configured 3D content comprises a 3D model of a scene; the estimated camera pose includes a camera position and a camera orientation; and the background replacement view comprises a view of the 3D model of the scene rendered using an AOV corresponding to the camera position and the camera orientation.

Aspect 35. The apparatus of any of Aspects 29 to 34, wherein: the configured 3D content comprises a 360° image of a scene; the estimated camera pose includes a camera orientation; and the background replacement view comprises a viewport of the 360° image of the scene, the viewport having an AOV corresponding to the camera orientation.

Aspect 36. The apparatus of any of Aspects 29 to 35, wherein the image data is a frame of video data included in a plurality of frames of video data.

Aspect 37. The apparatus of any of Aspects 29 to 36, wherein the lighting information is included in an equirectangular projection of the configured 3D content.

Aspect 38. The apparatus of any of Aspects 29 to 37, wherein the lighting information comprises scene lighting information associated with a scene represented in the 3D content.

Aspect 39. The apparatus of any of Aspects 29 to 38, wherein, to generate the relighting image, the at least one processor is configured to: mask out a background portion of the image data based on applying the segmentation mask to the image data; and process the foreground portion of the image data using the lighting information of the configured 3D content.

Aspect 40. The apparatus of Aspect 39, wherein: a foreground portion of the output image comprises relighting pixel data of the relighting output image, each pixel of the relighting pixel data corresponding to a respective pixel of the image data; and one or more pixels of the relighting pixel data represents modified tone or color information relative to the corresponding respective pixel of the image data, the modified tone or color information based on the light map.

Aspect 41. The apparatus of any of Aspects 39 to 40, wherein, to process the foreground portion of the image data using the lighting information, the at least one processor is configured to: determine a light map for the foreground portion of the image data based on learning three-dimensional surface characteristics of the foreground portion, the three-dimensional surface characteristics including at least one of a normal map or an albedo map; and modify one or more of a tone or color of the foreground portion of the image data to generate the relighting image, based on applying the light map to the foreground portion of the image data.

Aspect 42. The apparatus of any of Aspects 29 to 41, wherein the estimated camera pose comprises an estimated 6 degrees-of-freedom (6DOF) pose of a camera used to capture the image data, at a time of capture of the image data.

Aspect 43. The apparatus of any of Aspects 29 to 42, wherein the configured 3D content is a computer-generated (CG) 3D model of a scene selected from a plurality of CG 3D models of scenes.

Aspect 44. The apparatus of Aspect 43, wherein the at least one processor is configured to generate the 3D model of the scene using one or more generative artificial intelligence (AI) models.

Aspect 45. The apparatus of any of Aspects 43 to 44, wherein the at least one processor is configured to generate the 3D model of the scene using a same image capture device used to obtain the image data.

Aspect 46. The apparatus of any of Aspects 43 to 45, wherein the lighting information comprises scene lighting information associated with rendering the CG 3D scene.

Aspect 47. The apparatus of any of Aspects 43 to 46, wherein the at least one processor is configured to generate the background replacement view of the CG 3D scene using an image capture device used to obtain the image data.

Aspect 48. The apparatus of any of Aspects 44 to 47, wherein: the background replacement view comprises a view of a portion of the CG 3D scene, wherein the view of the portion of the CG 3D scene is associated with an AOV corresponding to the image data and the estimated camera pose.

Aspect 49. The apparatus of any of Aspects 43 to 48, wherein a background replacement view AOV is matched to the AOV corresponding to the image data and the estimated camera pose based on camera intrinsic information associated with an image capture device.

Aspect 50. The apparatus of any of Aspects 29 to 49, wherein the configured 3D content is a 360° image selected from a plurality of 360° images.

Aspect 51. The apparatus of any of Aspects 29 to 50, wherein the configured 3D content is based on an additional image captured using a same image capture device used to obtain the image data.

Aspect 52. The apparatus of Aspect 51, wherein the image data and the additional image are captured using a same camera of the image capture device.

Aspect 53. The apparatus of any of Aspects 51 to 52, wherein the image data is captured using a first camera of the image capture device, and wherein the additional image is captured using a second camera of the image capture device.

Aspect 54. The apparatus of any of Aspects 51 to 53, wherein: the background replacement view comprises a viewport in the additional image, wherein an AOV of the viewport is a subset of an AOV of the additional image; and the AOV of the viewport is determined based on camera intrinsic information associated with the image capture device.

Aspect 55. The apparatus of any of Aspects 29 to 54, wherein the estimated camera pose is determined based on inertial sensor data corresponding to an image capture device used to obtain the image data

Aspect 56. The apparatus of any of Aspects 29 to 55, wherein the HDR image indicative of lighting information comprises an HDR 360° image of the configured 3D content.

Aspect 57. A non-transitory computer-readable storage medium comprising instructions stored thereon which, when executed by at least one processor, causes the at least one processor to perform operations according to any of Aspects 1 to 28.

Aspect 58. A non-transitory computer-readable storage medium comprising instructions stored thereon which, when executed by at least one processor, causes the at least one processor to perform operations according to any of Aspects 29 to 56.

Aspect 59. An apparatus comprising one or more means for performing operations according to any of Aspects 1 to 28.

Aspect 60. An apparatus comprising one or more means for performing operations according to any of Aspects 29 to 56.

What is claimed is:

1. A method comprising:
determining an estimated camera pose corresponding to image data;
generating a background replacement view of a configured three-dimensional (3D) content, wherein the background replacement view is associated with an angle-of-view (AOV) based on the estimated camera pose;
determining a segmentation mask for the image data, the segmentation mask indicative of a foreground portion of the image data and a background portion of the image data;
generating a relighting image corresponding to at least a portion of the image data, wherein the relighting image is based on the segmentation mask and lighting information of the configured 3D content; and
generating an output image based on the relighting image and the background replacement view of the configured 3D content.

2. The method of claim 1, wherein:
a foreground portion of the output image comprises pixel data included in the relighting image; and
a background portion of the output image comprises pixel data included in the background replacement view of the configured 3D content.

3. The method of claim 1, further comprising performing camera motion stabilization to generate:
a stabilized camera pose, the stabilized camera pose based on one or more of the estimated camera pose or inertial sensor data corresponding to an image capture device used to obtain the image data; and
a stabilization warp grid corresponding to one or more stabilization corrections determined for the image data.

4. The method of claim 3, wherein the background replacement view comprises a view of the configured 3D content rendered using an AOV corresponding to the stabilized camera pose.

5. The method of claim 3, further comprising:
applying the one or more stabilization corrections to the image data, based on combining the stabilization warp grid and the image data to generate a stabilized image data; and
generating the relighting image based on combining at least a portion of the stabilized image data and the lighting information.

6. The method of claim 1, wherein the image data is a frame of video data included in a plurality of frames of video data.

7. The method of claim 1, wherein the lighting information is included in an equirectangular projection of the configured 3D content.

8. The method of claim 1, wherein the estimated camera pose comprises an estimated 6 degrees-of-freedom (6DOF) pose of a camera used to capture the image data, at a time of capture of the image data.

9. The method of claim 1, wherein the configured 3D content is a computer-generated (CG) 3D model of a scene selected from a plurality of CG 3D models of scenes.

10. The method of claim 9, wherein the 3D model of the scene is generated using a same image capture device used to obtain the image data.

11. The method of claim 9, wherein the background replacement view of the CG 3D scene is generated using an image capture device used to obtain the image data.

12. The method of claim 9, wherein:
the background replacement view comprises a view of a portion of the CG 3D scene, wherein the view of the portion of the CG 3D scene is associated with an AOV corresponding to the image data and the estimated camera pose.

13. The method of claim 1, wherein the configured 3D content is based on an additional image captured using a same image capture device used to obtain the image data.

14. The method of claim 13, wherein the image data and the additional image are captured using a same camera of the image capture device.

15. The method of claim 13, wherein the image data is captured using a first camera of the image capture device, and wherein the additional image is captured using a second camera of the image capture device.

16. The method of claim 13, wherein:
the background replacement view comprises a viewport in the additional image, wherein an AOV of the viewport is a subset of an AOV of the additional image; and
the AOV of the viewport is determined based on camera intrinsic information associated with the image capture device.

17. An apparatus for processing image data, comprising:
at least one memory; and
at least one processor coupled to the at least one memory, the at least one processor configured to:
determine an estimated camera pose corresponding to image data;
generate a background replacement view of a configured three-dimensional (3D) content, wherein the background replacement view is associated with an angle-of-view (AOV) based on the estimated camera pose;
determine a segmentation mask for the image data, the segmentation mask indicative of a foreground portion of the image data and a background portion of the image data;
generate a relighting image corresponding to at least a portion of the image data, wherein the relighting image is based on the segmentation mask and lighting information of the configured 3D content; and
generate an output image based on the relighting image and the background replacement view of the configured 3D content.

18. The apparatus of claim 17, wherein:
a foreground portion of the output image comprises pixel data included in the relighting image; and
a background portion of the output image comprises pixel data included in the background replacement view of the configured 3D content.

19. The apparatus of claim 17, wherein the at least one processor is further configured to perform camera motion stabilization to generate:
a stabilized camera pose, the stabilized camera pose based on one or more of the estimated camera pose or inertial sensor data corresponding to an image capture device used to obtain the image data; and
a stabilization warp grid corresponding to one or more stabilization corrections determined for the image data.

20. The apparatus of claim 19, wherein the background replacement view comprises a view of the configured 3D content rendered using an AOV corresponding to the stabilized camera pose.

21. The apparatus of claim 19, wherein the at least one processor is further configured to:
apply the one or more stabilization corrections to the image data, based on combining the stabilization warp grid and the image data to generate a stabilized image data; and
generate the relighting image based on combining at least a portion of the stabilized image data and the lighting information.

22. The apparatus of claim 17, wherein the image data is a frame of video data included in a plurality of frames of video data.

23. The apparatus of claim 17, wherein the lighting information is included in an equirectangular projection of the configured 3D content.

24. The apparatus of claim 17, wherein the estimated camera pose comprises an estimated 6 degrees-of-freedom (6DOF) pose of a camera used to capture the image data, at a time of capture of the image data.

25. The apparatus of claim 17, wherein the configured 3D content is a computer-generated (CG) 3D model of a scene selected from a plurality of CG 3D models of scenes.

26. The apparatus of claim 25, wherein the 3D model of the scene is generated using a same image capture device used to obtain the image data.

27. The apparatus of claim 25, wherein the background replacement view of the CG 3D scene is generated using an image capture device used to obtain the image data.

28. The apparatus of claim 25, wherein:
the background replacement view comprises a view of a portion of the CG 3D scene, wherein the view of the portion of the CG 3D scene is associated with an AOV corresponding to the image data and the estimated camera pose.

29. The apparatus of claim 17, wherein the configured 3D content is based on an additional image captured using a same image capture device used to obtain the image data.

30. The apparatus of claim 29, wherein the image data and the additional image are captured using a same camera of the image capture device.
